(19) United States
(12) Patent Application Publication
(10) Pub. No.: US 2026/0080383 A1
(43) Pub. Date: Mar. 19, 2026

(54) Vehicle Trip Builder System and Method Thereof

(71) Applicant: Trans Core, LP, Nashville, TN (US)

(72) Inventors: Stephen Finn, Encinitas, CA (US); Hong Chen, Valley Center, CA (US); Michael Lynch, Carlsbad, CA (US)

(21) Appl. No.: 19/393,950

(22) Filed: Nov. 19, 2025

Related U.S. Application Data
(63) Continuation-in-part of application No. 18/667,924, filed on May 17, 2024.

(51) Int. Cl. G06Q 20/14

(52) U.S. Cl. CPC G06Q 20/145; G06Q 2240/00

(57) ABSTRACT

A system, and method thereof, is provided for determining a vehicle trip on a roadway. The system may include a plurality of detection zones and a computer program product residing on a non-transitory computer readable medium and executable by one or more processors to direct performance of operations comprising: receiving one or more vehicle detection events corresponding to a given vehicle, each of the one or more vehicle detection events associated with one of a plurality of detection zones; storing a plurality of predefined trip patterns, each of the plurality of predefined trip patterns including at least one detection zone of the plurality of detection zones; and matching the one or more vehicle detection events to a longest matching trip pattern of the plurality of predefined trip patterns to define a trip.

### CROSS-REFERENCE TO RELATED APPLICATIONS

This application is a continuation-in-part of U.S. application Ser. No. 18/667,924, filed on May 17, 2024, which is hereby incorporated by reference in its entirety.

### BACKGROUND

### 1. Field of the Invention

The present disclosure relates generally to automatic toll collection systems, and more particularly, the present disclosure relates to a tolling system having a trip builder system and method implemented therein.

### 2. Description of the Prior Art

In applications like electronic or automatic toll collection, accurately identifying vehicles on the roadway and tracing their route for billing purposes is essential. Typically, vehicles are identified using transponders read by automatic vehicle identification (AVI) readers along the roadway or at toll collection stations. License plate reading systems, equipped with cameras, capture license plate images that are then processed by automatic optical character recognition (OCR) systems or manually by human operators to extract license plate numbers. However, both transponder and license plate reading systems are prone to errors, impacting the efficiency and revenue of the toll collection system.

Open ticket toll collection systems, which place toll gateways along mainline roadways rather than at entry and exit points, are favored for their reduced infrastructure needs. However, without clear entry and exit points, accurately determining when vehicles enter and exit the roadway becomes challenging. This makes it difficult to bill vehicles on a trip basis or develop accurate traffic models.

A conventional solution has been to charge a fixed amount for each toll gateway crossed. While straightforward, this approach lacks support for trip-based billing, which is desired for various reasons, including facilitating minimum and maximum trip charges, simplifying statements, creating accurate traffic models, and reducing losses from malfunctioning tolling equipment.

Existing systems typically blend electronic and manual toll collection, treating the electronic portion merely as a convenience (e.g., “fast lanes” or “express lanes” for bypassing manual toll booths). However, these systems largely replicate manual tolling rules rather than enabling true trip-based billing.

In complex automatic toll collection systems, system data errors can lead to incorrect billing. Furthermore, toll evasion poses another challenge through stolen or misused transponders and license plates. In conventional systems, error rates range from two percent to ten percent, resulting in lost revenue, increased customer support costs, and dissatisfaction when customers are billed incorrectly. When a vehicle cannot be identified via transponder or license plate reading, toll revenue is forfeited.

It is therefore desirable to develop a reliable trip determination system for open ticket toll collection and combined open ticket and closed ticket systems to support trip-based billing effectively.

### BRIEF SUMMARY

In view of at least some of the above-referenced problems in conventional tolling systems and the like, an exemplary object of the present disclosure is to provide a new automatic tolling system and method for determining a vehicle trip on a roadway. An exemplary such method may desirably feature providing and/or defining a plurality of trip patterns. The exemplary such method may further feature providing or receiving one or more vehicle detection events corresponding to a given vehicle wherein each of the one or more vehicle detection events associated with one of a plurality of detection zones. The exemplary such method may further feature matching the one or more vehicle detection events to a longest corresponding trip pattern of the plurality of predefined trip patterns to define a trip. The exemplary such method may further feature matching a first portion of the one or more vehicle detection events to one of the plurality of predefined trip patterns to define a first trip and matching a second portion of the one or more vehicle detection events to a different one of the plurality of predefined trip patterns to define a second trip.

In a particular embodiment, an exemplary method for determining a vehicle trip on a roadway as disclosed herein may include (a) providing one or more vehicle detection events corresponding to a given vehicle, each of the one or more vehicle detection events associated with one of a plurality of detection zones; (b) providing a plurality of predefined trip patterns, each of the plurality of predefined trip patterns including at least one detection zone of the plurality of detection zones; and (c) matching the one or more vehicle detection events to a longest corresponding trip pattern of the plurality of predefined trip patterns to define a trip.

In an exemplary aspect according to the above-referenced embodiment, the one or more vehicle detection events may include at least two vehicle detection events.

In another exemplary aspect according to the above-referenced embodiment, step (c) of the method may further include: determining an average travel time between pairs of detection zones of the plurality of detection zones for each of the plurality of trip patterns that include at least two detection zones of the plurality of detection zones; comparing a travel time of the given vehicle between a pair of detection zones associated with the at least two vehicle detection events with the determined average travel time between the pair of detection zones; and verifying the trip when a difference between the travel time and the average travel time is below a predetermined threshold.

In another exemplary aspect according to the above-referenced embodiment, the determined average travel time may be contemporaneous to the at least two vehicle detection events.

In another exemplary aspect according to the above-referenced embodiment, at least one of the plurality of predefined trip patterns may include non-consecutive detection zones.

In another exemplary aspect according to the above-referenced embodiment, each of the plurality of detection zones may be subdivided based on direction of travel information and each of the plurality of predefined trip patterns may include the direction of travel information.

In another exemplary aspect according to the above-referenced embodiment, at least one of the plurality of predefined trip patterns may include a first detection zone associated with a first direction of travel and a second detection zone associated with a second direction of travel different than the first direction of travel.

In another exemplary aspect according to the above-referenced embodiment, the first detection zone and the second detection zone may be positioned at a common location along the roadway.

In another exemplary aspect according to the above-referenced embodiment, step (c) of the method may further include: matching a first portion of the one or more vehicle detection events to one of the plurality of predefined trip patterns to define a first trip; and matching a second portion of the one or more vehicle detection events to one of the plurality of predefined trip patterns to define a second trip. Each vehicle detection event may be matched to no more than one of the first portion and the second portion.

In another embodiment, an exemplary system for determining a vehicle trip on a roadway as disclosed herein may include a plurality of detection zones and a computer program product residing on a non-transitory computer readable medium and executable by one or more processors to direct performance of operations comprising: receiving one or more vehicle detection events corresponding to a given vehicle, each of the one or more vehicle detection events associated with one of a plurality of detection zones; storing a plurality of predefined trip patterns, each of the plurality of predefined trip patterns including at least one detection zone of the plurality of detection zones; and matching the one or more vehicle detection events to a longest matching trip pattern of the plurality of predefined trip patterns to define a trip.

In an exemplary aspect according to the above-referenced embodiment, the one or more vehicle detection events may include at least two vehicle detection events.

In another exemplary aspect according to the above-referenced embodiment, the computer program product may further configured to direct performance of operations including: determining an average travel time between pairs of detection zones of the plurality of detection zones for each of the plurality of trip patterns that include at least two detection zones of the plurality of detection zones; comparing a travel time of the given vehicle between a pair of detection zones associated with the at least two vehicle detection events with the determined average travel time between the pair of detection zones; and verifying the trip when a difference between the travel time and the average travel time is below a predetermined threshold.

In another exemplary aspect according to the above-referenced embodiment, the determined average travel time may be contemporaneous to the at least two vehicle detection events.

In another exemplary aspect according to the above-referenced embodiment, at least one of the plurality of predefined trip patterns may include non-consecutive detection zones.

In another exemplary aspect according to the above-referenced embodiment, each of the plurality of detection zones may be subdivided based on direction of travel information and each of the plurality of predefined trip patterns may include the direction of travel information.

In another exemplary aspect according to the above-referenced embodiment, at least one of the plurality of predefined trip patterns may include a first detection zone associated with a first direction of travel and a second detection zone associated with a second direction of travel different than the first direction of travel.

In another exemplary aspect according to the above-referenced embodiment, the first detection zone and the second detection zone may be positioned at a common location along the roadway.

In another exemplary aspect according to the above-referenced embodiment, the computer program product is further configured to direct performance of operations including: matching a first portion of the one or more vehicle detection events to one of the plurality of predefined trip patterns to define a first trip; and matching a second portion of the one or more vehicle detection events to one of the plurality of predefined trip patterns to define a second trip. Each vehicle detection event may be matched to no more than one of the first portion and the second portion.

In another exemplary aspect according to the above-referenced embodiment, at least a portion of the plurality of predefined trip patterns may include various sequences of the plurality of detection zones.

In a further embodiment, an exemplary method for determining a vehicle trip on a roadway may include (a) providing one or more vehicle detection events corresponding to a given vehicle, each of the one or more vehicle detection events associated with a detection zone; (b) providing at least one predefined trip pattern including the detection zone; and (c) matching the one or more vehicle detection events to a longest matching trip pattern of the at least one predefined trip pattern to define a trip.

### BRIEF DESCRIPTION OF THE SEVERAL VIEWS OF THE DRAWINGS

FIG. 1 is a diagram of an embodiment of a system in accordance with the present disclosure.

FIG. 2 is a diagram of another embodiment of a system in accordance with the present disclosure.

FIG. 3 is a diagram of an embodiment of a roadway of the system of FIG. 1 or 2 in accordance with the present disclosure.

FIG. 4 is a diagram of another embodiment of a roadway of the system of FIG. 1 or 2 in accordance with the present disclosure.

FIG. 5 is a diagram of another embodiment of a roadway of the system of FIG. 1 or 2 in accordance with the present disclosure.

FIG. 6 is a flowchart of an embodiment of a method in accordance with the present disclosure.

FIG. 7 illustrates a first example roadway associated with trip building events for a vehicle.

FIG. 8 illustrates a second example roadway associated with trip building events for a vehicle.

FIG. 9 illustrates an example roadway system map for use with a congestion trip building system.

FIG. 10 illustrates a first vehicle trip building example based on a first detection point sequence shown in relation to a portion of the roadway system map of FIG. 9.

FIG. 11 illustrates a second vehicle trip building example based on a second detection point sequence shown in relation to a portion of the roadway system map of FIG. 9.

FIG. 12 illustrates a third vehicle trip building example based on a third detection point sequence shown in relation to a portion of the roadway system map of FIG. 9.

FIG. 13 illustrates an example roadway map for use with an excluded roadway or restricted roadway trip building system.

FIG. 14 is a flow chart showing steps of a first example method for conducting a tolling transaction based on trip building for a vehicle.

FIG. 15 is a flow chart showing steps of a second example method for conducting a tolling transaction based on trip building for a vehicle.

### DETAILED DESCRIPTION

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Reference throughout this specification to “one embodiment,” “an embodiment,” “another embodiment,” “optional embodiment” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “computing platform” or “platform” may include a computing environment where a portion of software can execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The computing platform may include one or more data storages. The computing platform may include a client application that executes on an external computing device and that interacts with the platform in a client-server architecture.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described, such software application able to both send and receive pertinent performance data.

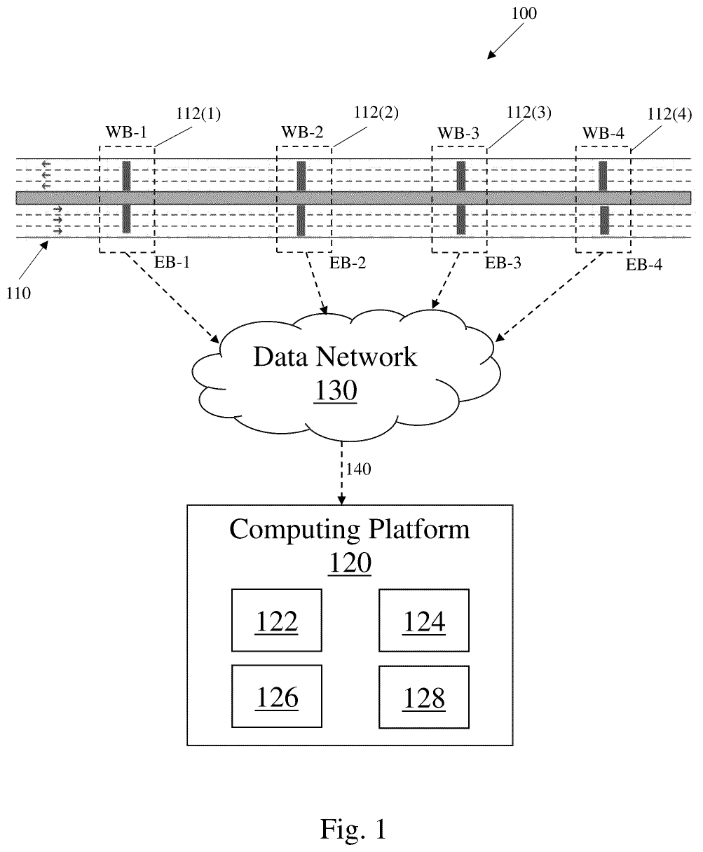

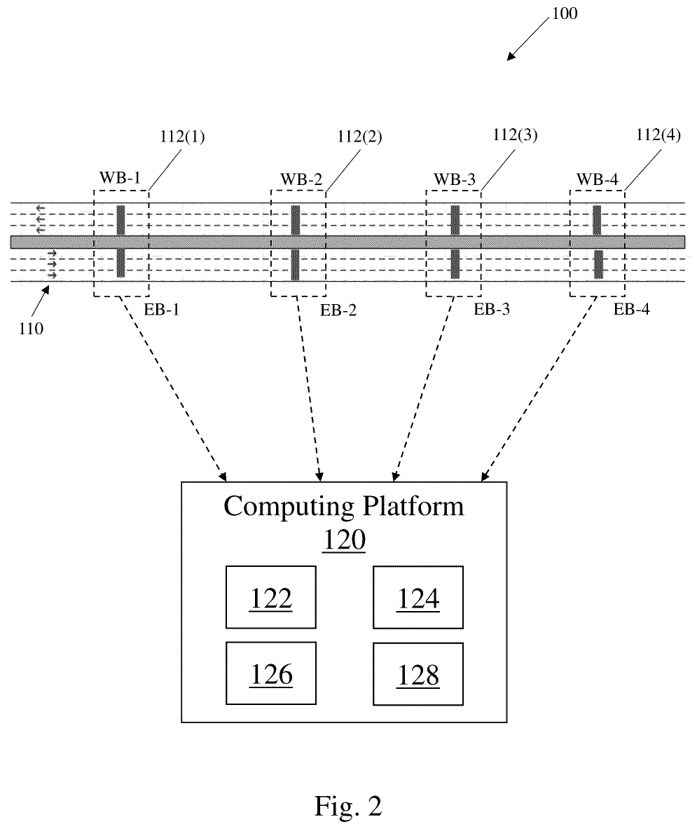

Referring to FIGS. 1-2, a system 100 for determining a vehicle trip on a roadway 110 is provided. The roadway 110 including at least one detection zone 112. The at least one detection zone 112 may also be referred to herein as a tolling station 112 or detection point 112. In certain optional embodiments, the roadway 110 may include a plurality of detection zones (e.g., 112(1), 112(2), 112(3), 112(4), etc.).

The system 100 may further include a computer program product 120 to analyze data (e.g., one or more vehicle detection events 140) received from the at least one detection zone 112. The computer program product 120 may also be referred to herein as a computing platform 120. In certain optional embodiments, as illustrated in FIG. 1, the computing platform 120 may be located remotely from the at least one detection zone 112, with the system 100 further including a data network 130 for communicating with the at least one detection zone 112. In other optional embodiments, as illustrated in FIG. 2, the computing platform 120 may be directly linked to each of the at least one detection zone 112. The computing platform 120 may include or reside on a non-transitory computer readable medium 122 and may be executable by one or more processors 124. The computing platform 120 may further include data storage 126. The one or more vehicle detection events 140 may be received by the computing platform 120 using the data network 130 or directly.

The system 100, or more specifically, the computing platform 120 may include a user interface (UI) 128 executable on the computing platform 120. In certain optional embodiments, the UI 128 may be executable on a computing device coupled to or wirelessly linked to the computing platform 120.

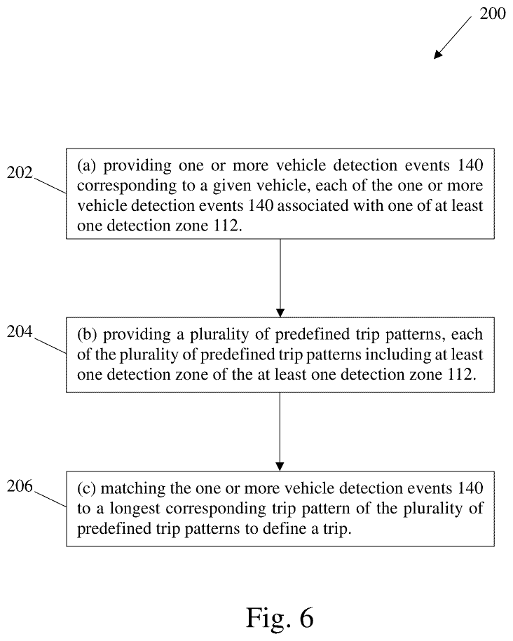

The computing platform 120 may be executable by the one or more processors 124 to direct performance of operations, which may be represented by a method 200 (as shown in FIG. 6) for determining a vehicle trip on the roadway 110. As such, the method 200 is executable by the system 100.

The method 200 may include (a) providing 202 one or more vehicle detection events 140 corresponding to a given vehicle. Each of the one or more vehicle detection events 140 may be associated with one of the at least one detection zone 112. As discussed above, the one or more vehicle detection events 140 may be received from the at least one detection zone 112. A detection event may be any event involving identification of a vehicle, a person associated with the vehicle, and/or a communication device associated with the vehicle and/or vehicle occupant, and/or the collection of data used to identify a vehicle, a person associated with the vehicle, and/or a communication device associated with the vehicle and/or vehicle occupant. Any type of vehicle data collection and/or identification system may be used including automatic license plate reader (ALPR) systems, wireless communication-based systems (e.g., radio-frequency identification (RFID) or other wireless communication protocols), video or camera-based systems, and roadside sensor-based systems. In various embodiments, a vehicle, person, or communication device may be detected and/or identified based on the systems described in U.S. Pat. Nos. 12,015,969 and 12,069,552, each of which are hereby incorporated by reference in its entirety. In various embodiments, a vehicle may be detected and/or identified based on any of the techniques or systems described in U.S. Pat. No. 12,437,285, U.S. application Ser. No. 18/236,989, or U.S. application Ser. No. 18/403,356, each of which are hereby incorporated by reference in its entirety.

The method 200 may further include (b) providing a plurality of predefined trip patterns (e.g., as show in Tables 1-4 below). Each of the plurality of predefined trip patterns may include at least one of the at least one detection zones 112. The plurality of predefined trip patterns may be received by and stored on the computing platform 120. The plurality of predefined trip patterns is infinitely customizable based on the needs of a tolling authority or tolling agency. As such, the plurality of predefined trip patterns may be programmed or selected by the tolling authority. For example, there may be n! (n factorial) possible trip patterns when considering a single direction of travel, where n equals the number of detections zones positioned along the roadway in a same direction of travel. Further for example, there may be n! (n factorial) possible trip patterns when considering a single direction of travel when considering only the opposite direction of travel. Further, there may be two (2) times n! (n factorial) possible trip patterns when considering both directions of travel, however, more trip patterns may be possible when considering trip patterns that include detections zones more than once, and more than one direction of travel.

The method 200 may further include (c) matching the one or more vehicle detection events 140 to a longest corresponding trip pattern of the plurality of predefined trip patterns to define a trip, as further discussed in the examples below. In various embodiments, a longest corresponding trip pattern may include the longest or most detection events (e.g., a longest sequence of chronological detection events). For example, a longest corresponding trip pattern may comprise a pattern sequence of detection zones/points/events having (1) a largest distance between a first and last detection point or zone defining the sequence of chronological detection events; and/or (2) a largest number of detection events. Once the trip has been matched to the vehicle, a toll fee may be charged to the user of the vehicle or an account associated with the vehicle. In various embodiments, a toll may be charged based on the number of determined trips or any other factor. For example, a charge to an account of a person associated with the vehicle may be applied. In various embodiments, the person associated with the vehicle or another party may be notified or informed of the charge toll fee or cost (e.g., by communicating or sending to a communication device of the person or the other party information indicating a toll fee that was charge).

In certain optional embodiments, the one or more vehicle detection events 140 may include at least two vehicle detection events. In accordance with this embodiment, step (c) of the method 200 may further include determining an average travel time between pairs of detection zones 112 for each of the plurality of trip patterns that include at least two detection zones 112, comparing an actual travel time of the given vehicle between a pair of detection zones 112 associated with the at least two vehicle detection events with the determined average travel time between the pair of detection zones 112, and verifying the trip when a difference between the travel time and the average travel time is below a predetermined threshold. The trip may be verified according to the above embodiment prior to processing the toll fee. In certain optional embodiments, predetermined threshold may be 10% greater than the average travel time. In other optional embodiments, the predetermined threshold may be 20% greater than the average travel time. In other optional embodiments, the predetermined threshold may be 30% greater than the average travel time. In other optional embodiments, the predetermined threshold may be 40% greater than the average travel time. In other optional embodiments, the predetermined threshold may be 50% greater than the average travel time. Overall, in various embodiments, the predetermined threshold may be increased or decreased based on traffic conditions (e.g., current traffic conditions and/or historical traffic conditions for a particular time of the day).

The average travel time may be contemporaneous to the at least two vehicle detection events. In other words, the average travel time may be calculated based on other vehicles traveling through the pair of detection zones prior to the given vehicle. The average travel time may be calculated based on other vehicles traveling through the pair of detection zones during a predefined time interval immediately preceding the at least two vehicle detection events of the given vehicle. In certain optional embodiments, the predefined time interval may be less than or equal to thirty (30) minutes. In other optional embodiments, the predefined time interval may be less than or equal to twenty-five (25) minutes. In other optional embodiments, the predefined time interval may be less than or equal to twenty (20) minutes. In other optional embodiments, the predefined time interval may be less than or equal to fifteen (15) minutes. In other optional embodiments, the predefined time interval may be less than or equal to ten (10) minutes. In other optional embodiments, the predefined time interval may be less than or equal to five (5) minutes. In other optional embodiments, the predefined time interval may be less than or equal to three (3) minutes. In other optional embodiments, the predefined time interval may be less than or equal to one (1) minute. In various embodiments, an average travel time may be set and applied to different corresponding pairs of detection points or zones. In various embodiments, an average travel time may be separately set for each pair of detection points or zones. In various embodiments, if a difference between an actual travel time and an average travel time is below a predetermined threshold, then the trip building systems described herein may collapse two initially formed trips (e.g., two trips involving different directions or a U-turn) into a single trip. Further, in various embodiments, an average travel time may be overridden to accommodate certain business rules that may allow for greater travel times between detection points or zones in view of driver behavior (e.g., to accommodate likely scenarios of a driver stopping to shop or eat at a location before traveling in a different or opposite direction).

Referring to FIGS. 1-5, different embodiments of the roadway 110 are provided. An example of allowable predefined trip patterns corresponding to FIGS. 1-2 is shown in Table 1 below.

TABLE 1
Predefined Trip Patterns

EB-1
EB-1, EB-2
EB-1, EB-3
EB-1, EB-2, EB-3
EB-2
EB-2, EB-3
EB-3
EB-4
EB-1, WB-1
EB-2, WB-1
WB-4, WB-3, WB-2, WB-1
WB-4, WB-3, EB-3, EB-4
WB-3, EB-3, EB-4

Transactions for the same vehicle are grouped together for trip building, for example due to a same license plate or a same RFID device being read at each of the at least one detection zone 112. Trip delineation depends on the toll agency's business rules. For example, transactions at Eastbound Plazas EB-1, EB-2, and EB-3 may be grouped into a trip, while EB-4 is considered a separate trip. Where a trip is formed across multiple vehicle detection events, a single toll is charged for the entire trip, as opposed to prior methodologies which charge a toll for each individual transaction. As can be seen in FIGS. 1-2 and Table 1, each of the at least one detection zones 112 may be subdivided based on direction of travel information and each of the plurality of predefined trip patterns may include the direction of travel information.

In certain optional embodiments according to Table 1, the one or more vehicle detection events 140 corresponding to the given vehicle may include EB-1 and EB-2. In accordance with this embodiment, the system 100 may match the one or more vehicle detection events 140 to trip pattern EB-1, EB-2. The system 100 may further determine the average travel time between EB-1 and EB-2 and compare the actual travel time of the given vehicle with the determined average travel time based on the predetermined threshold for trip verification purposes. For example, the given vehicle may remain on the roadway 110 between EB-1 and EB-2 and its actual travel time may be less than the predetermined threshold, in which case the trip is verified. In other example, the given vehicle may exit the roadway 110 and re-enter the roadway 110 between EB-1 and EB-2, thus causing its actual travel time to be greater than the average travel time and thereby causing the system 100 to split the trip into two separate toll fees rather than a trip toll fee.

In some embodiments according to Table 1, the one or more vehicle detection events 140 corresponding to the given vehicle may include only one of EB-1, EB-2, EB-3, EB-4. In this case, a trip may be defined with a single vehicle detection event. In other embodiments, the trip patterns may exclude single detection events from being defined as trips.

In other optional embodiments according to Table 1, the one or more vehicle detection events 140 corresponding to the given vehicle may include EB-1 and EB-3. In accordance with this embodiment, the detection zone at EB-2 may have not detected the given vehicle, or the given vehicle may have exited the roadway 110 prior to EB-2 and re-entered the roadway 110 after EB-2. In accordance with this embodiment, the system 100 may match the one or more vehicle detection events 140 to trip pattern EB-1, EB-3. The system 100 may further determine the average travel time between EB-1 and EB-3 and compare the actual travel time of the given vehicle with the determined average travel time based on the predetermined threshold for trip verification purposes. As such, at least one of the predefined trip patterns may include non-consecutive or non-adjacent detection zones 112 if the actual travel time of the vehicle is less than the determined average travel time based on the predetermined threshold.

In further optional embodiments according to Table 1, the one or more vehicle detection events 140 corresponding to the given vehicle may include EB-1 and WB-1. For example, the given vehicle may have exited while traveling eastbound on the roadway 110 after EB-1 and re-entered the roadway 110 westbound prior to WB-1. In accordance with this embodiment, the system 100 may forgo the verification process using a determined average travel time. This embodiment illustrates a trip including a first detection zone associated with a first direction of travel and a second detection zone associated with a second direction of travel different than the first direction of travel. Additionally, this embodiment illustrates the first and second detection zones being in a common location along the roadway 110, thus meaning that a trip involving a U-turn may be programmed and is acceptable. However, from Table 1, it is noted that it is possible to define a trip pattern as including different directions of travel based on detection zones positioned at different locations along the roadway 110 (e.g., EB-2, WB-1).

In further optional embodiments according to Table 1, the one or more vehicle detection events 140 corresponding to the given vehicle may include EB-1, EB-2, EB-3, and EB-4. In accordance with this embodiment, the method 200 may match a first portion of the one or more vehicle detection events 140 to one of the plurality of predefined trip patterns (e.g., EB-1, EB-2, EB-3) to define a first trip, and match a second portion of the one or more vehicle detection events 140 to one of the plurality of predefined trip patterns (e.g., EB-4) to define a second trip. It is noted that each vehicle detection event may be matched to no more than one of the first portion or the second portion.

In other optional embodiments, the one or more vehicle detection events 140 corresponding to the given vehicle may include various other combinations which may or may not match with one or more of the predefined trip patterns.

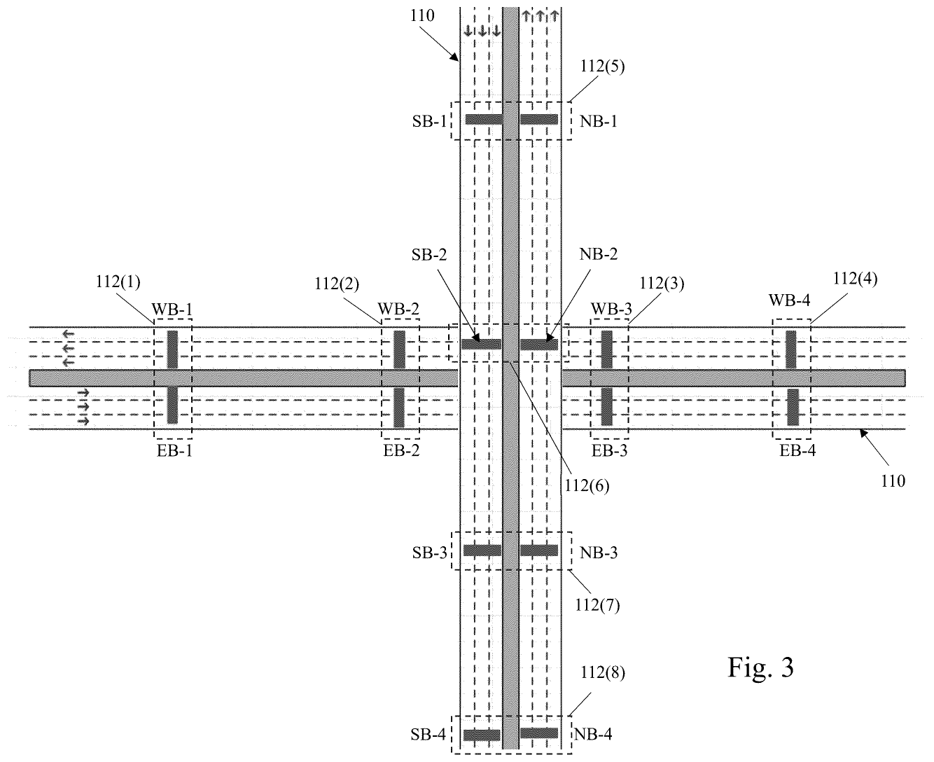

Another example of allowable predefined trip patterns corresponding to FIG. 3 is shown in Table 2 below.

TABLE 2
Predefined Trip Patterns

EB-1, EB-2
EB-1, EB-2, EB-3
EB-1, EB-2, EB-3, EB-4
EB-1, EB-3
EB-2, EB-3
EB-2, EB-4
EB-1, EB-2, NB-2, NB-1
EB-3, EB-4
EB-2, NB-2
SB-1, SB-2, WB-2, WB-1
NB-4, NB-3, NB-2
NB-4. NB-3, EB-3, EB-4
NB-2, SB-2

In certain optional embodiments, the one or more vehicle detection events 140 corresponding to the given vehicle may include EB-1, EB-2, NB-2, NB-1, SB-1, SB-2, WB-2, WB-1. In accordance with this embodiment, the method 200 may match a first portion of the one or more vehicle detection events 140 to one of the plurality of predefined trip patterns (e.g., EB-1, EB-2, NB-2, NB-1) to define a first trip, and match a second portion of the one or more vehicle detection events 140 to one of the plurality of predefined trip patterns (e.g., SB-1, SB-2, WB-2, WB-1) to define a second trip. The system 100 may verify the first and second trips by comparing the actual travel time with the determined average travel time based on the predetermined threshold for each pair of detection zones 112.

In other optional embodiments, the one or more vehicle detection events 140 corresponding to the given vehicle may include various other combinations which may or may not match with one or more of the predefined trip patterns.

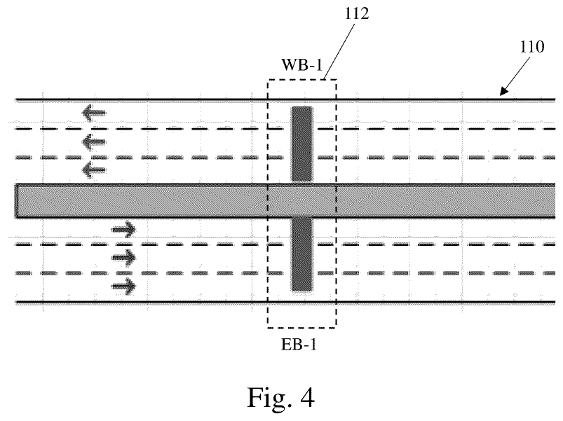

A further example of allowable predefined trip patterns corresponding to FIG. 4 is shown in Table 3 below.

TABLE 3
Predefined Trip Patterns

EB-1
EB-1, WB-1
WB-1
WB-1, EB-1

In certain optional embodiments, the one or more vehicle detection events 140 corresponding to a given vehicle may include EB-1. As discussed above with regard to Table 1, this embodiment illustrates a trip may be defined with a single vehicle detection event.

In other optional embodiments, the one or more vehicle detection events 140 corresponding to a given vehicle may include EB-1 and EB-2. As discussed above with regard to Table 1, this embodiment illustrates a trip including a first detection zone associated with a first direction of travel and a second detection zone associated with a second direction of travel different than the first direction of travel.

In accordance with FIG. 4 and Table 3, an embodiments of the method 200 may include (a) providing one or more vehicle detection events 140 corresponding to a given vehicle, each of the one or more vehicle detection events 140 associated with a detection zone 112; (b) providing at least one predefined trip pattern including the detection zone 112; and (c) matching the one or more vehicle detection events 140 to a longest matching trip pattern of the at least one predefined trip pattern to define a trip.

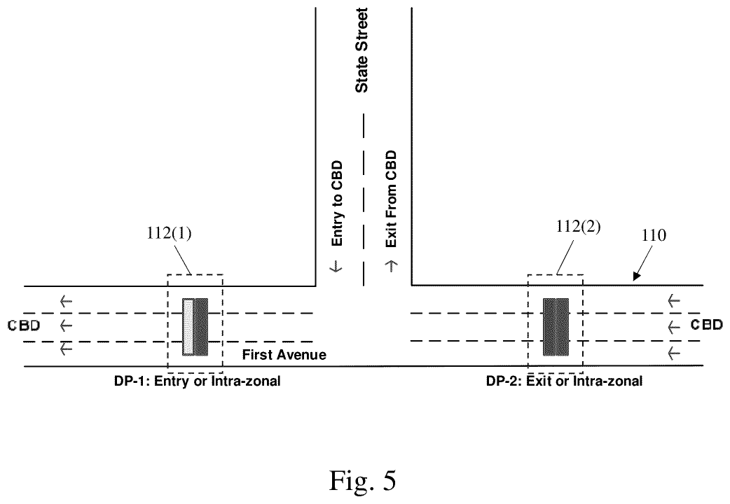

As illustrated in FIG. 5, the system 100 may be compatible with congestion pricing systems, such as, for example, a Central Business District (CBD) of an urban area. In such an embodiment, the at least one detection zone 112 of the CBD may include entry zones associated with entering the CBD, exit zones associated with exiting the CBD, intra-zonal zones positioned within the CBD, and various other special case zones. An example of allowable predefined trip patterns corresponding to the CBD of FIG. 5 is shown in Table 4 below.

TABLE 4
Predefined Trip Patterns

DP-2, DP-1
DP-1
DP-2

The detection zones in the CBD can have different roles depending on the full pattern of the one or more vehicle detection events 140. For example, if a vehicle detection event occurs at detection point one (DP-1), then the vehicle entered the CBD using State Street by turning right on First Avenue, however, if the DP-1 event is preceded by detection point two (DP-2), then the vehicle was already in the CBD and was traveling along First Avenue. Further for example, if the last event occurred at DP-2, then the vehicle exited the CBD by turning right on State Street, and if DP-2 is succeeded by DP-1, then the vehicle remained in the CBD and continued traveling along First Avenue. The determination of which role a detection point plays may be based on configurable patterns, as shown in Table 5 below.

TABLE 5

| | Prior DP Type | Current DP Type | Next DP Type | Role of DP |
|---|---|---|---|---|
| DP-1 | Exit/ | Entry/ | None | Intra-zonal |
| | Intra-zonal | Intra-zonal | | |
| DP-1 | None | Entry/ | None | Entry |
| | | Intra-zonal | | |
| DP-2 | None | Exit/ | Entry/ | Intra-zonal |
| | | Intra-zonal | Intra-zonal | |
| DP-2 | None | Exit/ | None | Exit |
| | | Intra-zonal | | |

Table 5 illustrates the importance of the type of detection point that precedes the current vehicle detection event when in the CBD, as well as the type of detection point that succeeds the current vehicle detection event. Rows 1 and 2 of Table 5 show the behavior of DP-1, which is either “entry” or “intra-zonal”, and rows 3 and 4 show the behavior of DP-2, which is either “exit” or “intra-zonal”. In Table 4 row 1 and Table 5 row 1, DP-1 is preceded by DP-2, so DP-1 is intra-zonal. In Table 4 row 2 and Table 5 row 2, DP-1 is by itself, so DP-1 is “entry”. In Table 4 row 1 and Table 5 row 3, DP2 is succeeded by DP-1, so DP-2 is “intra-zonal”. In Table 4 row 3 and Table 5 row 4, DP-2 is by itself, so DP-2 is “exit”.

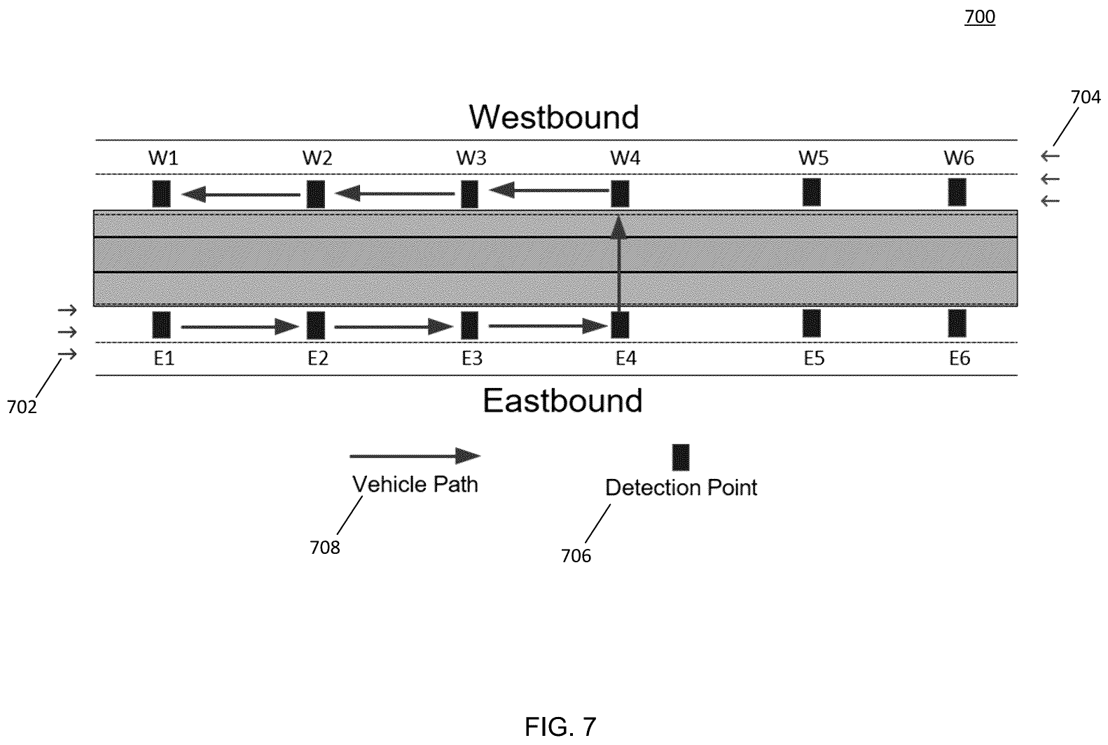

FIG. 7 illustrates a first example roadway 700. The roadway 700 includes an eastbound portion-indicated by an eastbound direction of travel 702—and a westbound portion—indicated by a westbound direction of travel 704. The eastbound portion of the roadway may be considered to be an eastbound corridor or an eastbound roadway. Similarly, the westbound portion of the roadway may be considered to be a westbound corridor or a westbound roadway. The roadway 700 may include detection points (or detection zones) 706. The detection points 706 may represent an area or portion of the roadway 700 where a vehicle may be detected (e.g., a vehicle crossing or traversing a detection point 706 may be detected in a manner that allows the vehicle to be identified). As shown in FIG. 7, the eastbound corridor includes detection points E1 through E6 and the westbound corridor includes detection points W1 through W6. FIG. 7 further includes a vehicle path 708 indicating a route a vehicle may take relative to the roadway 700 and/or the detection points 706.

In various prior trip building systems, trip building was corridor-based. That is, trips could be built only within a single corridor (i.e., a single direction). With these prior trip building systems, building a trip to span or include more than one corridor may be overly complex and cumbersome, if not impossible. As an example, with respect to the vehicle path 708 shown in FIG. 7, a vehicle is shown as traveling eastbound (E1→E4), making a U-turn, and then continuing westbound (W4→W1). With certain prior trip building system, this travel path for a vehicle would result in two separate trips:
Trip 1: E1→E2→E3→E4
Trip 2: W4→W3→W2→W1.
   Accordingly, the U-turn of the vehicle prevented the travel path of the vehicle (e.g., vehicle path 708) from being represented as a single trip.

For prior trip building systems, converting the two separate trips into one trip for purposes of tolling typically required the implementation of complex post-processing logic to merge the separate trips as well as the application of special tolling rules. This overall process was cumbersome, error-prone, and difficult to maintain for the prior trip building systems. However, with the flexible pattern configuration and pattern detection trip building approach described herein, trip building and associated tolling is no longer constrained by corridors. Accordingly, according to the systems and techniques described herein, instead of building trips within a single corridor, trips may be built based on the longest valid sequence of detection points in chronological order (e.g., regardless of corridors or a change in direction). As a result, a trip may span multiple corridors without any of the special handling required by the prior trip building systems.

With respect to the vehicle path 708 depicted in FIG. 7, and according to the systems and techniques described herein, if a U-turn is considered valid, then a pattern or sequence (e.g., a detection pattern or detection sequence) may be defined and stored in an appropriate configuration table (e.g., with respect to one or more detection points 706), such as:

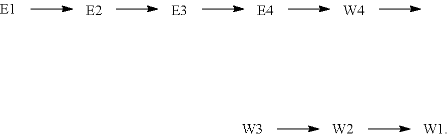

Any vehicle path matching this detection sequence may be built as one trip, regardless of any corridor changes. As a result, there is no need for complex post-processing or special tolling rules required by prior trip building systems, as the trip may be constructed correctly from the start. Further, the improved approach described herein is more flexible and easier to maintain. Additionally, the improved approach allows the improved trip building systems described herein to handle complex movements like U-turns natively during trip building (e.g., during a configuration stage where trips may be defined), eliminating the cumbersome post-processing logic required in prior trip building systems.

With the pattern or sequence detection approach employed by the improved systems described herein, trip building rules may be configured to allow any combination of detection points between any key start and end points. For example, if a requirement is that a vehicle must hit all eight detection points for a valid U-turn to be recognized, then the only valid U-turn pattern may be:

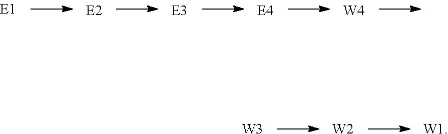

However, if intermediate detection points may be skipped, patterns may be defined accordingly. For example, if the only requirements imposed are that the trip starts at E1, makes a U-turn at E4→W4, and ends at W1, then this shorter pattern may also be valid:

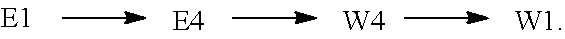

Additional patterns may be configured to cover all acceptable sequence variations, such as:

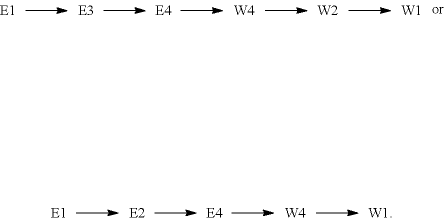

Overall, the flexibility provided by the improved systems described herein ensures that business rules drive trip building behavior (e.g., trip build setup/configuration and detection/tolling), allowing precise control over what constitutes a valid U-turn trip.

According to various embodiments described herein, the improved trip builder systems described herein may include a travel time validation layer. For example, after a trip is built or formed based on longest valid trip pattern as described herein, the improved trip building processes and systems described herein may apply a time-gap validation layer to ensure that transactions (e.g., vehicle detections) belong to the same trip. This subsequent step may occur after an initial trip is built based on pattern building or matching conducted in a previous step or layer of the processes and systems described herein.

In various embodiments, the improved trip building system described herein may calculate an expected or reasonable time gap between detection points or events using (e.g., an amount of time between two detection points 706 or events): (1) average speed in the zones involved; and (2) distance in miles between detection points. For the first technique, average speed in a zone (e.g., between two detection points 706) may be determined by observing and/or measuring the speeds of other vehicles traversing a particular portion of a roadway (e.g., the roadway 700). Under either technique or approach, an estimated or expected amount of travel time may be determined (e.g., an estimated or expected travel time threshold may be determined). In various embodiments described herein, the actual travel time of a vehicle between detection points may be observed (e.g., between detection points E3 and E4 of FIG. 7) and compared to the expected travel time threshold. If the actual vehicle travel time is less than the expected travel time threshold (or if a difference between the actual travel time and the expected travel time is below a predetermined threshold), then a trip built for the vehicle based on identification of the vehicle at various detection points 706 may be considered to be a single trip (or validated). In contrast, if the actual vehicle travel time is greater than the expected travel time threshold (or if a difference between the actual travel time and the expected travel time is greater than a predetermined threshold), then a trip built for the vehicle based on identification of the vehicle at various detection points 706 may be split into more than one trip.

An expected travel time threshold may be determined and set for any portion of a roadway (e.g., any portion of the roadway 700), including across one or more corridors, and/or between any two detection points (e.g., between any two detection points such as between W4 and W2). In various embodiments—for example for special cases such as a U-turn involving a driver that may leave a roadway for an extended period—default travel time thresholds may be overridden. A trip building/pattern matching configuration table may allow customized travel times for specific detection points (e.g., detection points 706) to be defined. If this configuration table is empty, a default expected travel time threshold may be determined to apply. However, if the configuration table is populated, then the trip building systems described herein may use the provided custom travel time thresholds or values provided for specific detection point pairs.

As an example, with reference to FIG. 7 and an allowable U-turn between detection point E4 and W4, a customizable travel time threshold may be defined as:

$$E 4 \to W 4 = 2 hours .$$

In doing so, a trip build that includes E4 and W4 will remain intact as a single trip if the travel time (or time gap) for a vehicle is less than 2 hours, and will be split up across two or more trips if the travel time (or time gap) for the vehicle exceeds 2 hours. In this manner, customizable time gaps may accommodate expected off roadway activity (e.g., shopping at a mall or eating at a restaurant) before the vehicle travels a return leg, in accordance with desired business rules governing set up of the trip building system.

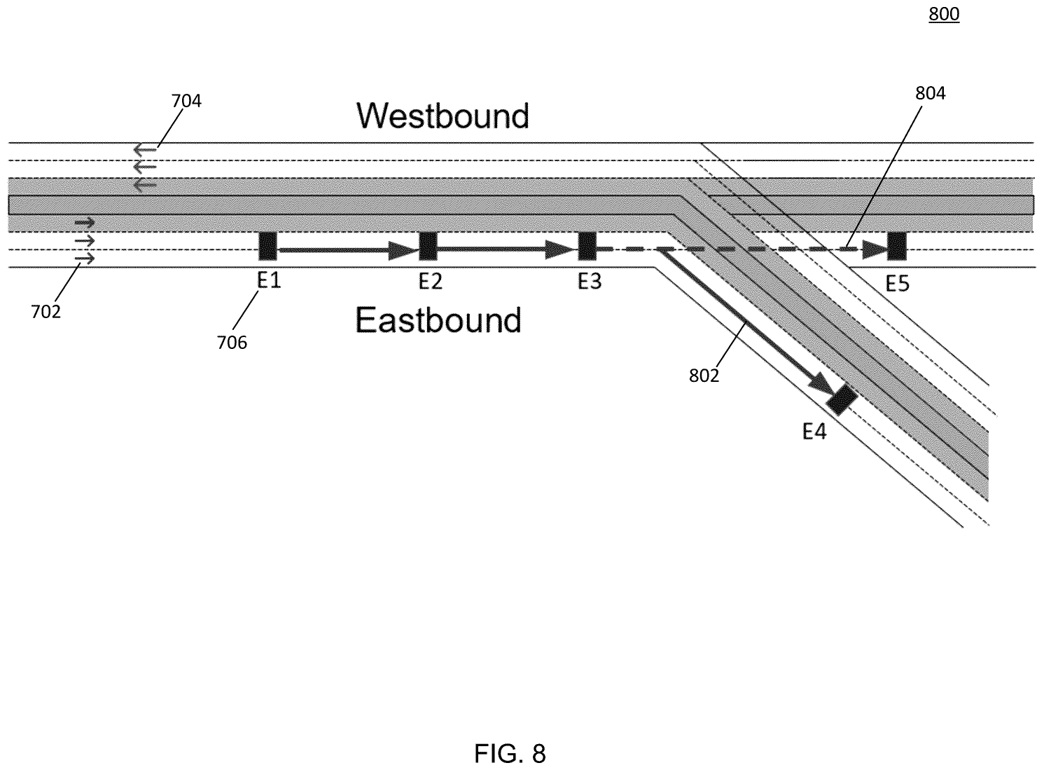

FIG. 8 illustrates a second example roadway 800. The roadway 800 includes an eastbound portion—indicated by an eastbound direction of travel 702—and a westbound portion—indicated by a westbound direction of travel 704. The eastbound portion of the roadway may be considered to be an eastbound corridor or an eastbound roadway. Similarly, the westbound portion of the roadway may be considered to be a westbound corridor or a westbound roadway. The roadway 800 may include detection points 706. The roadway 800 may include multiple branching destinations. For example, with respect to a vehicle travelling eastbound starting at detection point E1, a vehicle may branch towards detection point E4 (considered to be a first branch or branching destination 802) or the vehicle may branch towards detection point E5 (considered to be a second branch or branching destination 804). As shown, each branch of the roadway 800 includes one detection point (e.g., either detection point E4 or detection point E5).

According to the improved pattern building and/or detection processing of the trip building techniques and systems described herein, only trips that match valid patterns—and involving only one destination (e.g., with a vehicle travelling down either the first branch 802 or the second branch 804 but not both)—are allowed. For example, with reference to FIG. 8, possible trips may include:
Trip 1: E1→E2→E3→E4 (Destination 1/Branch 802)
Trip E1→E2→E3→E5 (Destination 2/Branch 804).

This approach prevents a vehicle from being associated with a trip that is not possible (e.g., physically not possible) such as E1→E2→E3→E4→E5, which may occur due to, for example, erroneous vehicle detection at a detection point 706. According to the techniques described herein, the trip building system will not configure and/or allow a valid detection sequence to contain both E4 and E5, so a trip can never include transactions from both destinations. This ensures that trips reflect real travel paths without requiring complex cleanup logic. By defining valid patterns at the configuration stage, the trip building systems described herein ensure that trips are built correctly—even in corridors with branching destinations—while maintaining flexibility for future changes.

The trip building systems described herein ensure that trips are built according to a longest valid pattern of detection points. In doing so, trips containing sequences of detection points that do not match any predefined pattern are prevented. As an example, and with reference to a vehicle travelling eastbound on the roadway 700 of FIG. 7, the following detection sequence may be observed:
Observed detections: E1→E2→E3→E2→E3→E4.
   The observed sequence may represent construction of the vehicle detection sequence for the vehicle (e.g., based on the vehicle detection event information provided or indicated). Further to the example, valid trip patterns (e.g., predetermined trips built during a configuration stage) may include the following (which may be non-exhaustive):
Valid pattern A: E1→E2→E3→E4
Valid pattern B: E1→E2→E3
Valid pattern C: E2→E3→E4
Valid pattern D: E3→E4.
   Notably, the set of valid patterns does not include a pattern matching the entire observed detection sequence of E1→E2→E3→E2→E3→E4. Consequently, according to the techniques described herein, the trip building process may implement the following:
[1] Starting with the first detection event (e.g., observed detection at E1), build or construct the longest valid sequence of vehicle detection events (e.g., valid sequence B: E1→E2→E3);
[2] Next, when the sequence breaks (e.g., at the second observed detection E2), the current trip being built ends (e.g., as determined by comparing the constructed sequence of vehicle detection events provided from observation/data collection to the set of predefined valid detection sequences or patterns);
[3] After ending the first trip, begin a next trip from the next observed detection (e.g., at the second observed detection E2) and match the further observed detections to the next longest valid trip sequence (e.g., to valid sequence C: E2→E3→E4); and
[4] Repeat steps [1]-[3] recursively until all vehicle detections are assigned to a trip. Continuing with this example, the observed detection sequence of E1→E2→E3→E2→E3→E4 would be broken into two trips with trip 1 including E1→E2→E3 and trip 2 including E2→E3→E4. Vehicle tolling charges may then be applied to the vehicle in accordance with the two trips.

The recursive trip building or pattern formation technique described herein ensures that a constructed trip includes every valid observed detection for a vehicle and never includes an invalid detection sequence (or at least significantly reduces a likelihood that a trip includes an invalid detection sequence). Further, constructed trips will always reflect the longest valid travel path defined for a particular configuration or roadway. Lastly, in various embodiments, the number of valid trips or detection sequences given n detection points may be 2ⁿ−1.

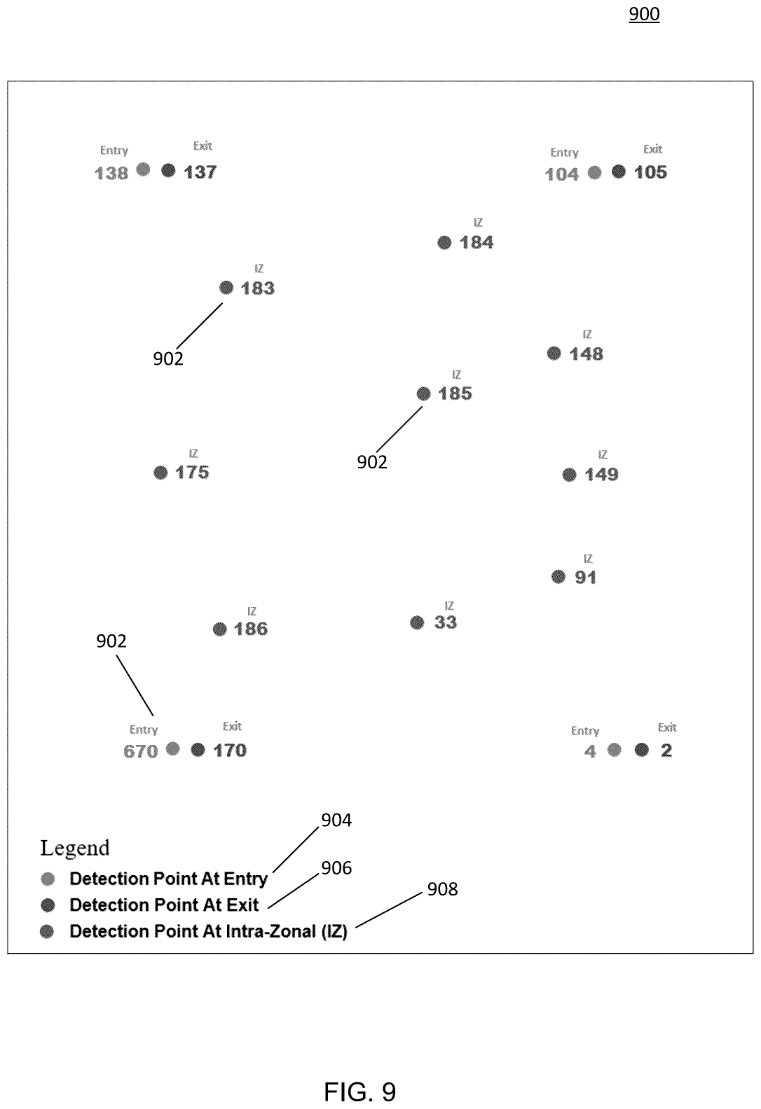

As described earlier and further herein, the techniques described herein may be applied to a congestion pricing, roadway usage, and/or city congestion trip building system. FIG. 9 illustrates an example roadway system map 900 for use with a congestion trip building system. The map 900 illustrates different types of detection points (or detection point types). Specifically, as shown in FIG. 9, the map 900 includes multiple detection points 902 (not all detection points are labeled for clarity). The map 900 may represent a portion of an urban roadway system and the detection points 902 may represent detection points along different roadways of the overall roadway system.

The legend of the map 900 indicates the different types of detection points 902. A first detection point type 904 may be a detection point at an entry to the system. A second detection point type 906 may be a detection point at an exit of the system. A third detection point type 908 may be a detection point at an intra-zonal (IZ) detection point. As shown in FIG. 9, each detection point 902 may be associated with a detection point reference number (e.g., 183) and detection point type (e.g., IZ).

Vehicle trips in certain areas such as cities or other urban areas may be different from vehicle trips on highways in that a vehicle may travel in any direction, or even circle. According to various embodiments, the trip building systems described herein may organize or collect all same-vehicle transactions (e.g., detections) for a day and then identifies trip start and end points using detection point type (DPT) patterns or sequences. A database may store all valid DPT sequences that define a trip. Table 6, below, lists valid DPT sequences that may be used to define a trip for a vehicle in relation to the roadway system map 900.

TABLE 6

Detection Point Type Pattern
Entry-Exit-
Entry-IZ-Exit-
Entry-
Entry-IZ-
IZ-Exit-
IZ-
Exit-

As an example, according to the first row of Table 6, a valid trip may comprise a vehicle detection at an entry point 904 and then a vehicle detection at an exit point 906.

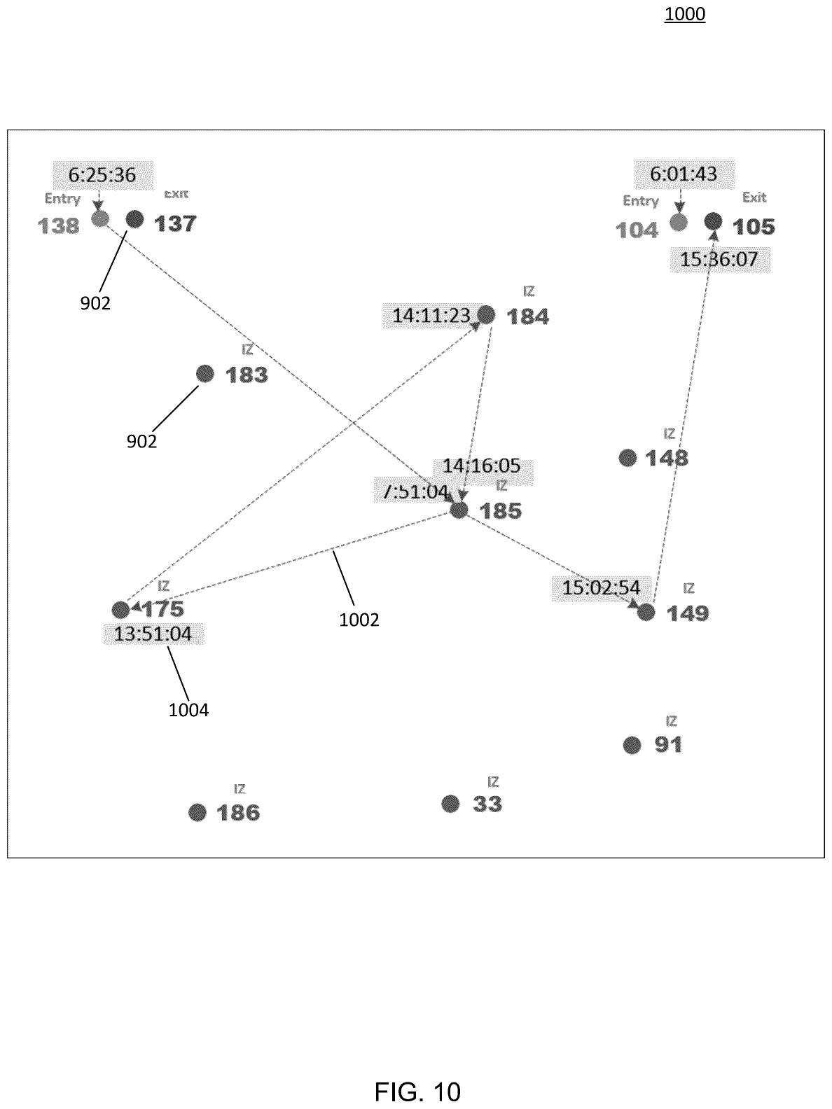

FIG. 10 illustrates a first trip building example 1000 using DPT sequences based on a portion of the map 900 of FIG. 9 and the valid DPT sequences of Table 6. As shown in FIG. 10, the first trip building example 1000 indicates a vehicle path 1002 and timestamps 1004. The vehicle path 1002 indicates the detection points 902 where the vehicle was detected. Each timestamp 1004 may indicate a time when the vehicle was detected at a particular detection point 902. Table 7, below, shows example data collected for an example vehicle based on the first trip building example 1000 of FIG. 10. As shown, Table 7 provides the timestamp for when the vehicle was detected at a specific detection point 902 (e.g., based on a detection point ID) and further indicates the detection point type for the specific detection point. Based on the information collected in Table 7, the trip building systems described herein may construct one or more trips for the vehicle based on matching the data of Table 7 to the predefined DPT patterns of Table 6, according to further processing rules described below.

TABLE 7

| TimeStamp | Dection Point ID | Dection Point Type |
|---|---|---|
| 6:25:36 | 138 | Entry |
| 7:51:04 | 185 | IZ |
| 13:51:04 | 175 | IZ |
| 14:11:23 | 184 | IZ |
| 14:16:05 | 185 | IZ |
| 15:02:54 | 149 | IZ |
| 15:36:07 | 105 | Exit |

As a first step, the trip building systems described herein may construct an initial DPT string of “Entry-IZ-IZ-IZ-IZ-IZ-Exit,” based on all of the detection point types indicated in Table 7 (e.g., based on all of the detection events collected for a vehicle over a certain period of time as shown by the vehicle path 1001). Next, the trip building systems described herein may consolidate consecutive instances of intra-zonal detection points “IZ” to a single instance of an intra-zonal detection point “IZ.” In doing so, an updated or modified DPT sequence is formed as “Entry-IZ-Exit.” This modified DPT sequence of “Entry-IZ-Exit” matches the predefined DPT trip pattern from row 2 of Table 6, shown below in Table 8.

TABLE 8

Detection Point Type Pattern
Entry-Exit-
Entry-IZ-Exit-
Entry-
Entry-IZ-
IZ-Exit-
Exit-

Based on this matching, the trip building system may form a complete trip as shown below in Table 9:

TABLE 9

| Trip | TimeStamp | Dection Point ID | Dection Point Type |
|---|---|---|---|
| Trip #1 | 6:25:36 | 138 | Entry |
| | 7:51:04 | 185 | IZ |
| | 13:51:04 | 175 | IZ |
| | 14:11:23 | 184 | IZ |
| | 14:16:05 | 185 | IZ |
| | 15:02:54 | 149 | IZ |
| | 15:36:07 | 105 | Exit |

Accordingly, in the DPT patterns shown in Table 6, each instance of an intra-zonal detection point “IZ” may represent more than one intra-zonal detection point (e.g., two or more consecutive intra-zonal detection points). A tolling transaction may be conducted based on the trip (Trip #1) determined for the vehicle. In various embodiments, the tolling transaction may be based on the distance travel, the particular trip, the time of day, occupancy, traffic congestion, or any other factor.

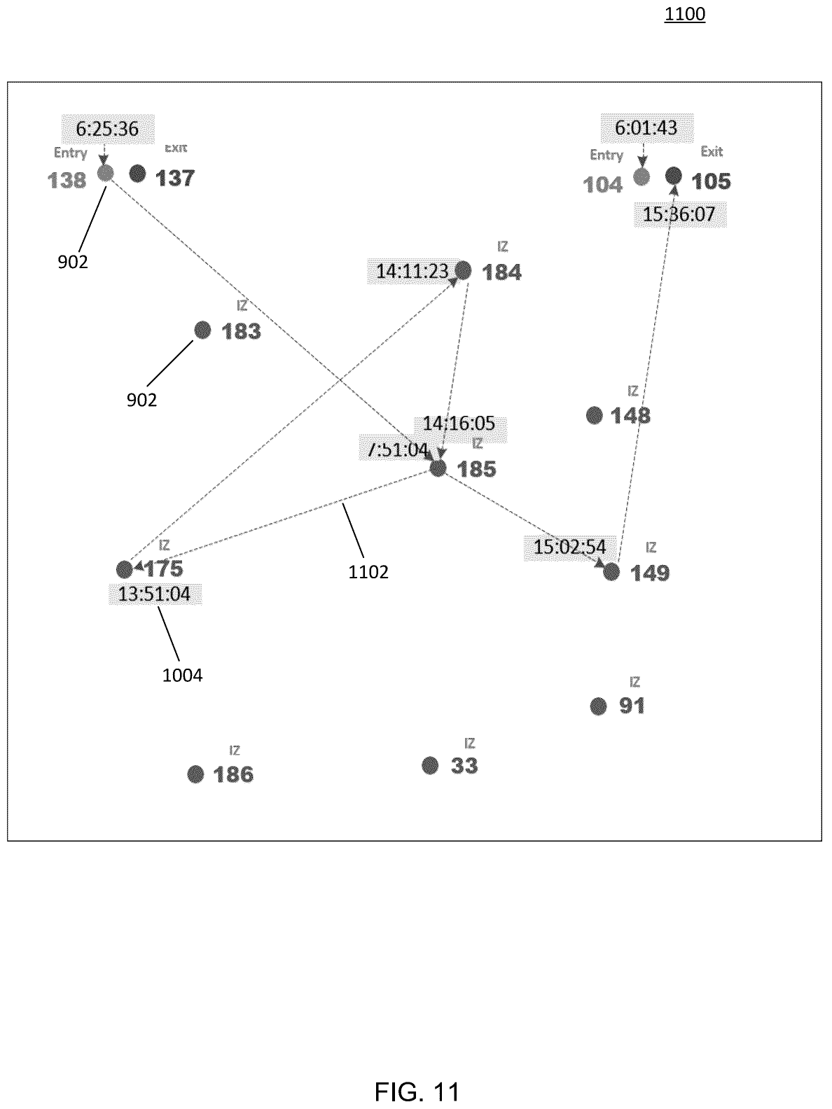

FIG. 11 illustrates a second trip building example 1100 using DPT sequences based on a portion of the map 900 of FIG. 9 and the valid DPT sequences of Table 6. As shown in FIG. 11, the second trip building example 1100 indicates a vehicle path 1102 with timestamps 1004 for each time the vehicle was detected at a detection point 902. Table 10, below, shows example data collected for an example vehicle based on the second trip building example 1100 of FIG. 11. As shown, Table 10 provides the timestamp for when the vehicle was detected at a specific detection point (e.g., based on a detection point ID) and further indicates the detection point type for the specific detection point. Based on the information collected in Table 10, the trip building systems described herein may construct one or more trips for the vehicle based on matching the data of Table 10 to the predefined DPT patterns of Table 6, again in view of the processing rules described herein.

TABLE 10

| TimeStamp | Dection Point ID | Dection Point Type |
|---|---|---|
| 6:01:43 | 104 | Entry |
| 6:25:36 | 138 | Entry |
| 7:51:04 | 185 | IZ |
| 13:51:04 | 175 | IZ |
| 14:11:23 | 184 | IZ |
| 14:16:05 | 185 | IZ |
| 15:02:54 | 149 | IZ |
| 15:36:07 | 105 | Exit |

As described in relation to the first trip building example 1000 of FIG. 10, as a first step, the trip building systems described here construct an initial DPT string of “Entry-Entry-IZ-IZ-IZ-IZ-IZ-Exit” based on all of the vehicle data collected and as shown in Table 10. Table 11, below, illustrates the processing of the information of Table 10. As shown in Table 11, the first column indicates initial DPT sequences, with the first row of this column initially showing the full DPT sequence of “Entry-Entry-IZ-IZ-IZ-IZ-IZ-Exit.”

Next, consecutive instances of intra-zonal “IZ” detections may be consolidated. This is shown in the second column of Table 11. Specifically, the first row of the “Consolidated DPT String” column shows that the longer sequence of “Entry-Entry-IZ-IZ-IZ-IZ-IZ-Exit” (from the first row of the “Initial DPT String” column) has been consolidated to “Entry-Entry-IZ-Exit.” This consolidated sequence is then compared to the valid DPT patterns of Table 6, with the result of the comparison indicated in the first row of the third column labeled “Is Pattern Defined.” As shown below in Table 11, the consolidated DPT sequence of “Entry-Entry-IZ-Exit” is not a valid sequence; therefore, the first row of the fourth column “Conclusion” indicates that this consolidated DPT string is not a valid trip.

TABLE 11

| Initial | Consolidated | Is | | |
|---|---|---|---|---|
| DPT | DPT | Pattern | | |
| String | String | Defined | Conclusion | Trip |
| Entry-Entry-IZ- | Entry-Entry-IZ-Exit- | No | Invalid Trip | |
| IZ-IZ-IZ-IZ-Exit- | Entry-Entry-IZ- | No | Invalid Trip | |
| | Entry-Entry- | No | Invalid Trip | |
| | Entry- | Yes | Valid Trip | Trip #1 |
| Entry-IZ-IZ-IZ- | Entry-IZ-Exit- | Yes | Valid Trip | Trip #2 |
| IZ-IZ-Exit- | | | | |

Because a match for the first consolidated DPT string was not found, the trip building systems described herein next removes the last DPT element from the consolidated DPT sequence and compares the result to the patterns of Table 6. This is shown in the second row of the “Consolidated DPT String” column with “Entry-Entry-IZ-Exit” sequence being modified to “Entry-Entry-IZ.” This first modified consolidated DPT sequence is again compared to the valid DPT patterns of Table 6 to attempt to locate a match. The results, as shown in Table 11, indicate that the first modified consolidated DPT sequence of “Entry-Entry-IZ” also does not form a valid trip.

Continuing, the trip building systems described herein again removes the last DPT element of the first modified consolidated DPT sequence to form a second modified consolidated DPT sequence of “Entry-Entry” (third row of the “Consolidated DPT String” column) and again compares this further modified consolidated pattern to the DPT sequences of Table 6. With no match found yet again, as shown in the fourth row of the “Consolidated DPT String” column of Table 11, a third modified consolidated DPT string of “Entry” is formed. The third modified consolidated DPT string of “Entry” matches a valid DPT sequence of Table 6 (e.g., row 3 of Table 6). Table 11 therefore indicates that this third modified consolidated DPT string is indeed a defined pattern and forms a valid trip (e.g., “Trip #1”) as indicated in the fifth column of Table 11, albeit with a single detection point type.

To handle the remaining detection point events after forming the first trip, the trip building systems herein begin with the remaining detection point data of “Entry-IZ-IZ-IZ-IZ-IZ-Exit,” as shown in the second row of the “Initial DPT String” column of Table 11. As described herein, this pattern is consolidated based on consecutive instances of “IZ” detections to form a consolidated DPT sequence of “Entry-IZ-Exit,” as shown in the fifth row of the “Consolidated DPT String” column of Table 11. This consolidated sequence matches the second row of Table 6 and so forms a valid sequence as indicated in Table 11. A second trip may then be formed based on this matched pattern as shown. Table 12, below, shows the two DPT sequence types that are matched to the initial vehicle data of Table 10 to form the resulting two vehicle trips shown in Table 13, also below.

TABLE 12
Detection Point Type Pattern

Entry-Exit-
Entry-IZ-Exit-
Entry-
Entry-IZ-
IZ-Exit-
IZ-
Exit-

TABLE 13

| Trip | TimeStamp | Dection Point ID | Dection Point Type |
|---|---|---|---|
| Trip #1 | 6:01:43 | 104 | Entry |
| | 6:25:36 | 138 | Entry |
| | 7:51:04 | 185 | IZ |
| Trip #2 | 13:51:04 | 175 | IZ |
| | 14:11:23 | 184 | IZ |
| | 14:16:05 | 185 | IZ |
| | 15:02:54 | 149 | IZ |
| | 15:36:07 | 105 | Exit |

One or more tolling transactions may be conducted based on the trips (Trip #1 and Tip #2) determined for the vehicle. In various embodiments, the tolling transactions may be based on the distance travel, the particular trip, the number of trips, the time of day, occupancy, traffic congestion, or any other factor.

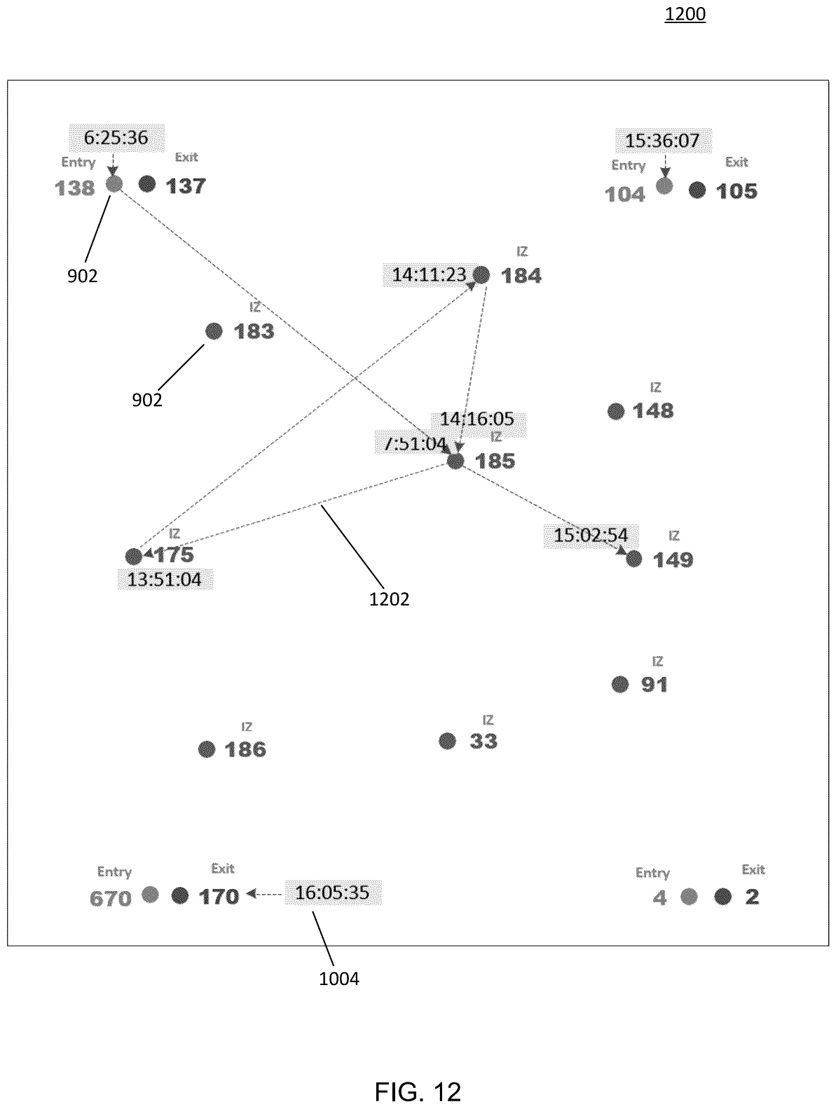

FIG. 12 illustrates a third trip building example 1200 using DPT sequences based on a portion of the map 900 of FIG. 9 and the valid DPT sequences of Table 6. As shown in FIG. 12, the third trip building example 1200 indicates a vehicle path 1202 with timestamps 1004 for each time the vehicle was detected at a detection point 902. Table 14, below, shows example data collected for an example vehicle based on the third trip building example 1200 of FIG. 12. As shown, Table 14 provides the timestamp for when the vehicle was detected at a specific detection point (e.g., based on a detection point ID) and further indicates the detection point type for each detection point. Based on the information collected in Table 14, the trip building systems described herein may construct one or more trips for the vehicle based on matching the data of Table 14 to the predefined DPT patterns of Table 6, using the recursive consolidation and comparison techniques described herein.

TABLE 14

| TimeStamp | Dection Point ID | Dection Point Type |
|---|---|---|
| 6:25:36 | 138 | Entry |
| 7:51:04 | 185 | IZ |
| 13:51:04 | 175 | IZ |
| 14:11:23 | 184 | IZ |
| 14:16:05 | 185 | IZ |
| 15:02:54 | 149 | IZ |
| 15:36:07 | 104 | Entry |
| 16:05:35 | 170 | Exit |

Table 15, below, shows the processing of the collected vehicle data shown in Table 14. As shown in Table 15, the initial DPT sequence of “Entry-IZ-IZ-IZ-IZ-IZ-Entry-Exit” is first consolidated to “Entry-IZ-Entry-Exit.” This consolidated DPT sequence is then further modified to “Entry-IZ-Entry” and then “Entry-IZ” (e.g., by sequentially removing the last DPT element of the sequence after a match is not found) before a match to a DPT pattern of Table 6 is found. The “Entry-IZ” pattern forms a first trip, as indicated in Table 15 and Table 16, below. The remaining DPT sequence of “Entry-Exit” is then processed to find a second match to an entry of Table 6, as further indicated in Tables 15 and 16. The result of the processing of the vehicle data of Table 14 results in the formation of two trips, as shown in detail in Table 17. One or more tolling transaction, as described herein, may then be conducted based on the trip determination information represented in Table 17.

TABLE 15

| Initial | Consolidated | Is | | |
|---|---|---|---|---|
| DPT | DPT | Pattern | | |
| String | String | Defined | Conclusion | Trip |
| Entry-IZ-IZ-IZ- | Entry-IZ-Entry-Exit- | No | Invalid Trip | |
| IZ-IZ-Entry-Exit- | Entry-IZ-Entry- | No | Invalid Trip | |
| | Entry-IZ- | Yes | Valid Trip | Trip #1 |
| Entry-Exit- | Entry-Exit- | Yes | Valid Trip | Trip #2 |

TABLE 16
Detection Point Type Pattern

Entry-Exit-
Entry-IZ-Exit-
Entry-
Entry-IZ-
IZ-Exit-
IZ-
Exit-

TABLE 17

| Trip | TimeStamp | Dection Point ID | Dection Point Type |
|---|---|---|---|
| Trip #1 | 6:25:36 | 138 | Entry |
| | 7:51:04 | 185 | IZ |
| | 13:51:04 | 175 | IZ |
| | 14:11:23 | 184 | IZ |
| | 14:16:05 | 185 | IZ |
| | 15:02:54 | 149 | IZ |
| Trip #2 | 15:36:07 | 104 | Entry |
| | 16:05:35 | 170 | Exit |

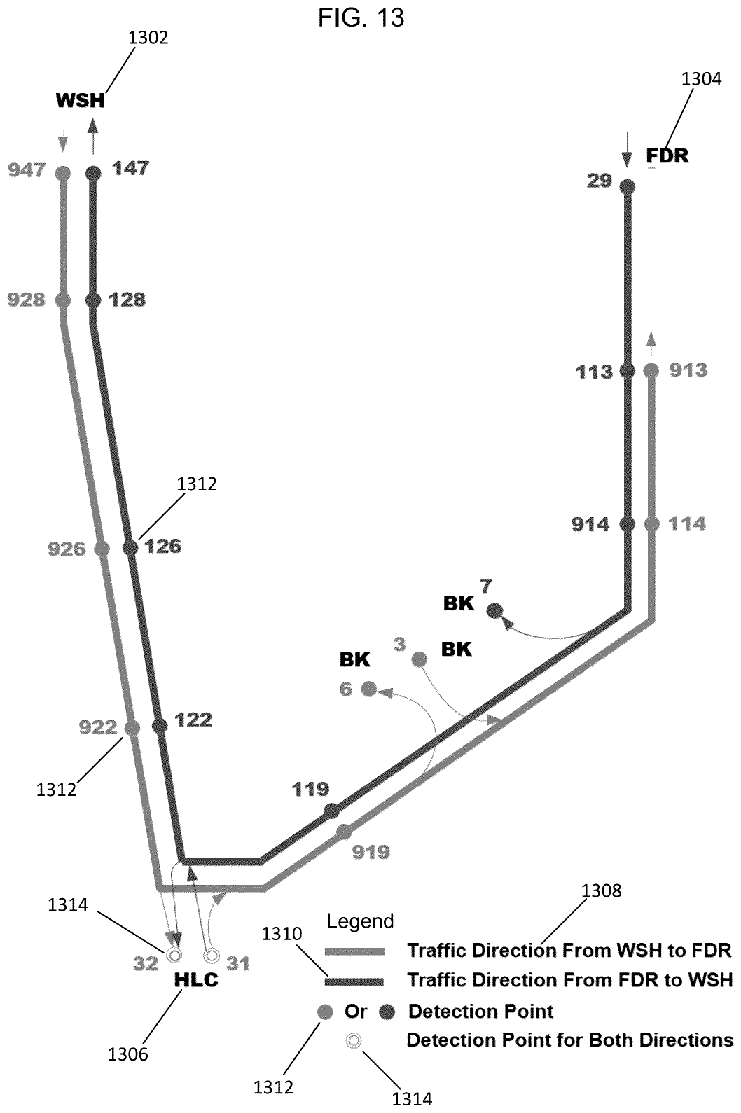

The techniques and system described herein may be applied to an excluded roadway or a restricted roadway. FIG. 13 illustrates an example roadway system map 1300 for use with an excluded roadway or restricted roadway trip building system. The map 1300 may represent portion of an urban area such as, for example, lower Manhattan with roadway 1302 representing a portion of the West Side Highway (represented in FIG. 13 as WSH), roadway 1304 representing a portion of the Franklin D. Roosevelt East River Drive (represented in FIG. 13 as FDR), and roadway 1306 representing a portion of the Hugh L. Carey Tunnel (HLC).

The legend of FIG. 13 shows a first traffic direction 1308 from WSH to FDR and a second traffic direction 1310 from FDR to WSH. Further, the legend of the map 1300 indicates a first type of detection point 1312 that may represent a detection point used for a single traffic direction and indicates a second type of detections point 1312 that may represent a detection point used for tow (both) traffic directions (not all detection points are labeled for clarity). Each type of detection point—1312 or 1314—may be associated with a detection point ID (DPID).

The map 1300 may represent a manner for which transactions for a vehicle may be collected based on the vehicle's interaction with detections points 1312 and/or 1314. The trip building systems described herein may use the detection point data collected for a vehicle over a predetermined period of time (e.g., over the course of a day) to determine where a trip for the vehicle begins and ends based on collected sequences of DPIDs. A database may store DPID sequences that may be defined as valid trips. The trip building systems described herein may compare the DPID data for a vehicle to the information stored in the database to determine one or more trips for a particular vehicle. After determining the one or more trips for the vehicle, one or more tolling transactions may be conducted based on the determined vehicle trips.

Table 18, below, represents example first information that may be stored in a database for a restricted or excluded roadway trip building system as described herein. As shown, Table 18 may include a Route ID column, a Detection Point IP Pattern or Sequence, and a Pattern or Sequence Description. The data in Table 18 may represent predefined or allowable trips from WSH 1302 to FDR 1304 along the first direction 1308. Data collected for a vehicle (e.g., based on data collected for a vehicle at a detection point 1312 and/or 1314) may be compared to the predefined trips stored in Table 18 to determine one or more trips for the vehicle. As an example, Table 19, below, shows example data collected for a specific vehicle over a predetermined period of time.

TABLE 18

| | Detection Point | |
|---|---|---|
| RouteID | ID Pattern | Pattern Descrition |
| 131 | 947-928-926-922-919-114- | Had all DPs |
| | 913- | |
| 131 | 947-926-922-919-114-913- | Absent 1 DPs: 928 |
| 131 | 947-928-922-919-114-913- | Absent 1 DPs: 926 |
| 131 | 947-928-926-919-114-913- | Absent 1 DPs: 922 |
| 131 | 947-928-926-922-114-913- | Absent 1 DPs: 919 |
| 131 | 947-928-926-922-919-913- | Absent 1 DPs: 114 |
| 131 | 947-922-919-114-913- | Absent 2 DPs: 928, 926 |
| 131 | 947-926-919-114-913- | Absent 2 DPs: 928, 922 |
| 131 | 947-926-922-114-913- | Absent 2 DPs: 928, 919 |
| 131 | 947-926-922-919-913- | Absent 2 DPs: 928, 114 |
| 131 | 947-928-919-114-913- | Absent 2 DPs: 926, 922 |
| 131 | 947-928-922-114-913- | Absent 2 DPs: 926, 919 |
| 131 | 947-928-922-919-913- | Absent 2 DPs: 926, 114 |
| 131 | 947-928-926-114-913- | Absent 2 DPs: 922, 919 |
| 131 | 947-928-926-919-913- | Absent 2 DPs: 922, 114 |
| 131 | 947-928-926-922-913- | Absent 2 DPs: 919, 114 |
| 131 | 947-919-114-913- | Absent 3 DPs: 928, 926, 922 |
| 131 | 947-922-114-913- | Absent 3 DPs: 928, 926, 919 |
| 131 | 947-922-919-913- | Absent 3 DPs: 928, 926, 114 |
| 131 | 947-926-114-913- | Absent 3 DPs: 928, 922, 919 |
| 131 | 947-926-919-913- | Absent 3 DPs: 928, 922, 114 |
| 131 | 947-926-922-913- | Absent 3 DPs: 928, 919, 114 |
| 131 | 947-928-114-913- | Absent 3 DPs: 926, 922, 919 |
| 131 | 947-928-919-913- | Absent 3 DPs: 926, 922, 114 |
| 131 | 947-928-922-913- | Absent 3 DPs: 926, 919, 114 |
| 131 | 947-928-926-913- | Absent 3 DPs: 922, 919, 114 |
| 131 | 947-114-913- | Absent 4 DPs: 928, 926, 922, |
| | | 919 |
| 131 | 947-919-913- | Absent 4 DPs: 928, 926, 922, |
| | | 114 |
| 133 | 947-922-913- | Absent 4 DPs: 928, 926, 919, |
| | | 114 |
| 131 | 947-926-913- | Absent 4 DPs: 928, 922, 919, |
| | | 114 |
| 131 | 947-928-913- | Absent 4 DPs: 926, 922, 919, |
| | | 114 |

TABLE 19

| Time Stamp | Detection Point ID |
|---|---|
| 8:29:42 | 947 |
| 8:32:25 | 928 |
| 08:36:12 | 926 |
| 08:39:03 | 922 |
| 08:48:09 | 919 |
| 09:59:32 | 114 |
| 10:03:16 | 913 |

As shown, Table 19 includes a timestamp for when the vehicle was detected at a detection point that is identified by a detection point ID. To process the collected data of Table 19 for the vehicle, the trip building systems described herein may first construct an initial sequence of “947-928-926-922-919-114-913” which may represent all of the DPIDs for the vehicle (e.g., the complete DPID sequence of the vehicle). This initial DPID sequence may then be compared to the predefined trips stored for the excluded roadway system (e.g., the predefined sequences of Table 18). If a match is found, a trip for the vehicle is determined. If a match is not found, then the trip building system may sequentially remove the last DPID element of the sequence and compare this modified sequence to the predefined trip data until a match is found. For this example, the initial (full) sequence matches the first row of Table 19. Consequently, a trip for the vehicle is determined and defined as shown in Table 20, below. A tolling fee or charge may then be assessed to the vehicle based on the determine trip represent in Table 20.

TABLE 20

| Trip | Time Stamp | Detection Point ID |
|---|---|---|
| Trip #1 | 8:29:42 | 947 |
| | 8:32:25 | 928 |
| | 08:36:12 | 926 |
| | 08:39:03 | 922 |
| | 08:48:09 | 919 |
| | 09:59:32 | 114 |
| | 10:03:16 | 913 |

Table 21, below, represents second example information that may be stored in a database for a restricted or excluded roadway trip building system as described herein. As shown, Table 21 may include a Route ID column, a Detection Point IP Pattern or Sequence, and a Pattern or Sequence Description. The data in Table 21 may represent predefined or allowable trips from WSH 1302 to HILC 1306 along the first direction of travel 1308. Data collected for a vehicle (e.g., based on data collected for a vehicle at a detection point 1312 and/or 1314) may be compared to the predefined trips stored in Table 21 to determine one or more trips for the vehicle. As an example, Table 22, below, shows example data collected for a specific vehicle over a predetermined period of time.

TABLE 21

| RouteID | Detection Point ID Pattern | Pattern Description |
|---|---|---|
| 111 | 947-928-926-922-32- | Had all DPs |
| 111 | 947-926-922-32- | Absent 1 DPs: 928 |
| 111 | 947-928-922-32- | Absent 1 DPs: 926 |
| 111 | 947-928-926-32- | Absent 1 DPs: 922 |
| 111 | 947-922-32- | Absent 2 DPs: 928, 926 |
| 111 | 947-926-32- | Absent 2 DPs: 928, 922 |
| 111 | 947-928-32- | Absent 2 DPs: 926, 922 |
| 111 | 947-32- | Absent 3 DPs: 928, 926, 922 |

TABLE 22

| Time Stamp | Detection Point ID |
|---|---|
| 08:25:23 | 947 |
| 08:29:42 | 928 |
| 09:08:01 | 32 |
| 09:29:42 | 922 |

As shown, Table 22 includes a timestamp for when the vehicle was detected at a detection point that is identified by a detection point ID. To process the collected data of Table 22 for the vehicle, the trip building systems described herein may first construct an initial sequence of “947-928-32-922” which may represent all of the DPIDs for the vehicle (e.g., the complete DPID sequence of the vehicle). This initial DPID sequence may then be compared to the predefined trips stored for the excluded roadway system (e.g., the predefined sequences of Table 21). If a match is found, a trip for the vehicle is determined. If a match is not found, then the trip building system may sequentially remove the last DPID element of the sequence and compare this modified sequence to the predefined trip data until a match is found. This processing of the data is shown with respect to Table 23, below.

TABLE 23

| Detection Point ID String | Is The Pattern Defined | Conclusion |
|---|---|---|
| 947-928-32-922- | No | Invalid Trip |
| 947-928-32- | Yes | Valid Trip |
| 922- | No | Invalid Trip |

For this example, the initial sequence does not match any data shown in any row of Table 21. Accordingly, a first modified DPID sequence is formed as “947-928-32,” which matches data provided in Table 21. Consequently, this first modified sequence is declared or determined to be a first trip for the vehicle. Table 24, below, shows the first trip as defined for the vehicle based on the data collected as shown in Table 22. The leftover DPID of “922” is not found in Table 21. As a result, this detection data may be determined to be erroneous.

TABLE 24

| Trip | Time Stamp | Detection Point ID |
|---|---|---|
| Trip #1 | 08:25:23 | 947 |
| | 08:29:42 | 928 |
| | 09:08:01 | 32 |

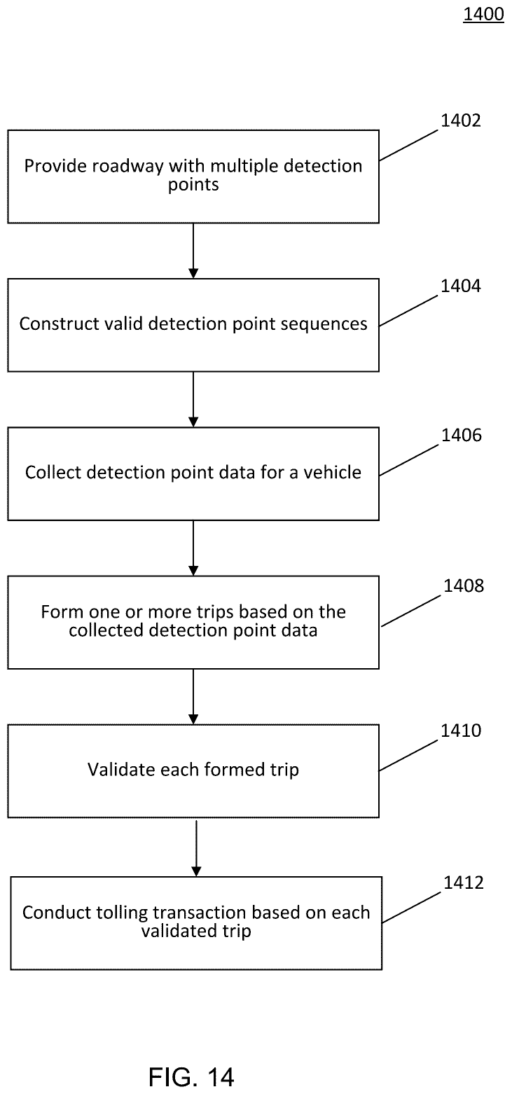

FIG. 14 is a flow chart 1400 showing steps of an example first method for conducting a tolling transaction based on trip building for a vehicle. The example method shown in the flow chart 1400 may be applicable to any tolling environment including, for example, an open road tolling environment, a congestion pricing tolling environment, a roadway usage tolling environment, or any other tolling environment associated with vehicle trip building. One, some, or all steps of the example method of FIG. 14 may be performed by any of trip building systems described herein based on any of the techniques described herein. Steps of the example method of FIG. 14 may be omitted, performed in other orders, and/or otherwise modified, and/or one or more additional steps may be added.

At 1402, a roadway with multiple detection points is provided. The roadway may include one or more corridors, may include one or more different roadway segments, and/or one or more different driving directions for a vehicle (e.g., the roadway depicted in FIG. 1-5 or 7-8). Each detection point may be capable of identifying a vehicle and/or collecting data that may be used to identify a vehicle. Each detection point may be capable of generating a timestamp for when a vehicle is detected at the detection point. Each detection point may be uniquely identified.

At 1404, valid detection points sequences may be determined. Valid detection point sequences may represent valid trips for a vehicle including, for example, valid routes a vehicle may take with respect to the roadway provided in step 1402. Any number of valid detection point sequences may be generated or built for a particular roadway. The valid detection point sequences may be stored in a database.

At 1406, detection point data for a vehicle is collected. The detection point data may be collected over any predetermined period of time (e.g., a 12-hour period). The detection point data may indicate the time of day (e.g., via a timestamp) when the vehicle was detected and an identifier of the corresponding detection point (e.g., a detection point ID) where the vehicle was detected.

At 1408, one or more trips for the vehicle may be formed based on the collected detection point data from step 1406. The trips may be constructed based on the techniques described herein including, for example, the trip building techniques described in relation to FIGS. 7-8. As an example, the full sequence of detection point IDs for the vehicle may be formed (e.g., in chronological order). The full sequence of detection point IDs for a vehicle may be determined based on a vehicle identifier or other information used to determine all of the detection points where a vehicle was detected. The full sequence of detection points IDs may be compared to the set of valid detection point sequences constructed in step 1404.

If the comparison results in a match, then a trip (e.g., a single trip comprising the full sequence of detection point IDs for the vehicle) may be determined and/or declared for the vehicle. If the comparison does not result in a match, then a match to the longest sequence of detection points (e.g., a sequence containing the most detection points starting from the first detection point) from the set of valid detection point sequences constructed in step 1404 is determined, thereby forming a first trip for the vehicle. The longest sequence of detection points may be based on the first detection point and may include all detection points thereafter (e.g., in chronological order) until the sequence deviates from a matching valid sequence stored in the database. Next, the remining portion of the full sequence of detection points IDs of the vehicle (e.g., starting with the next detection point ID of the sequence that was not included in the first declared trip) is compared to the set of valid detection point sequences constructed in step 1404 and stored in the database. Again, a match to the longest sequence of detection points (e.g., a sequence containing the most detection points) from the set of valid detection point sequences constructed in step 1404 is determined, thereby forming a second trip or next trip for the vehicle. This process repeats (e.g., recursively with respect to the results obtained and the leftover detection point IDs of the vehicle detection sequence) until all detection points of the vehicle's full collected chronological sequence of detection points are matched and identified as part of a trip. As a result, the full sequence of detection points IDs for the vehicle is broken into one or more separate trips for purposes of tolling.

At step 1410, each constructed trip for the vehicle may be validated. Step 1410 may be performed after each trip is constructed or after all trips for the vehicle are constructed. Under either scenario, validation may include verification or confirmation of the amount of time the vehicle took to travel between sequential detection points. As an example, a time gap between detection points may be determined. The time gap may be based on average speed information for a portion of the roadway between the detection points (e.g., based on measurements of the amount of time vehicles require to travel between the two detection points such as, for example, an average amount of time). The time gap may be based on the distance between the detection points which may also be used to generate an estimated or expected travel time for a vehicle between the detection points (e.g., based on historical data collected for travel times between the detection points for the time of day during which the vehicle traveled between the two detection points). In this manner, each segment of a trip for a vehicle (e.g., between two consecutive detection points) may compared to an expected travel time.

If the vehicle travel time is less than then expected travel time (e.g., or a maximum travel time threshold based on the expected travel time or if a difference between the vehicle travel time and the expected travel time is less than a predetermined threshold), then the trip may be validated. If the vehicle travel time exceeds the expected amount of time (e.g., or the maximum travel time threshold or if a difference between the vehicle travel time and the expected travel time is greater than a predetermined threshold), then the trip may be declared to be invalid and broken into one or more additional trips. Alternatively or in addition thereto, a check may be performed to determine if an exception has been flagged for the travel time between certain detection points. In some situations, an extended amount of time may be deemed permissible to account for special business rules that are based on typical vehicle/user behavior. In various embodiments, the expected travel time may be increased to allow for certain driver behavior (e.g., slower drivers) or to accommodate unexpected delays not predicted based on historical data.

At step 1412, the validated trips are used to conduct one or more tolling transactions for the vehicle. The tolling transaction may be based on the number of trips determined for the vehicle, the time of day, the type of vehicle, or any other factors described herein.

The method depicted and described in relation FIG. 14 ensures that every valid transaction of the vehicle (e.g., each valid vehicle detection) is included in one of the trips constructed for the vehicle. The method also prevents invalid sequences from being declared as a vehicle trip. Further, the constructed trips are ensured to reflect the longest valid travel path (e.g., the longest sequence of chronological detection points) defined during configuration (e.g., step 1404).

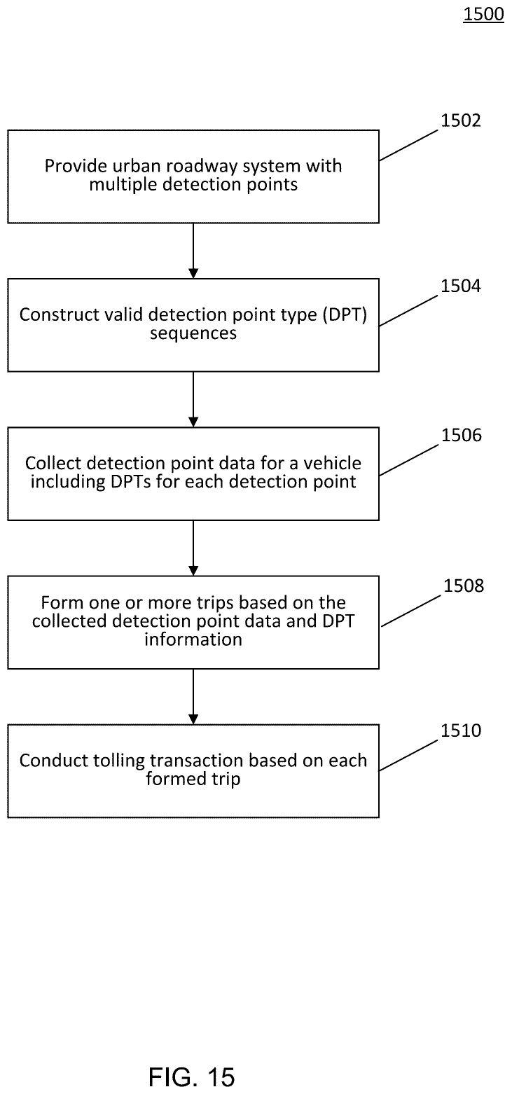

FIG. 15 is a flow chart 1500 showing steps of a second example method for conducting a tolling transaction based on trip building for a vehicle. The example method shown in the flow chart 1500 may be applicable to any tolling environment including, for example, a city congestion tolling environment or a congestion pricing tolling environment, or any other tolling environment associated with vehicle trip building. One, some, or all steps of the example method of FIG. 15 may be performed by any of trip building systems described herein based on any of the techniques described herein. Steps of the example method of FIG. 15 may be omitted, performed in other orders, and/or otherwise modified, and/or one or more additional steps may be added.

At 1502, a set of roadways with multiple detection points is provided. The set of roadways may include one or more corridors, may include one or more different roadway segments, and/or one or more different driving directions for a vehicle (e.g., the roadways depicted in FIGS. 9-12). The set of roadways may be part of an urban area, a congestion pricing tolling zone, or an area including various interconnected roadways. Each detection point may be capable of identifying a vehicle and/or collecting data that may be used to identify a vehicle. Each detection point may be capable of generating a timestamp for when a vehicle is detected at the detection point. Each detection point may be uniquely identified. Each detection point may be associated with a detection point type such as, for example, an entry detection point, an exit detection point, or an intra-zonal (IZ) detection point.

At 1504, valid detection points sequences may be determined. Valid detection point sequences may represent valid trips for a vehicle including, for example, valid routes a vehicle may take with respect to the set of roadways provided in step 1502. Any number of valid detection point sequences may be generated or built for a particular roadway. The valid detection point sequences may be stored in a database. The valid detection point sequences may be based on the types associated with the detection points. As an example, Table 6 may represent various detection point sequences that may be considered to be valid that are based on detection point types (DPTs).

At 1506, detection point data for a vehicle is collected. The detection point data may be collected over any predetermined period of time (e.g., a 12-hour period). The detection point data may indicate the time of day (e.g., via a timestamp) when the vehicle was detected and an identifier of the corresponding detection point (e.g., a detection point ID) where the vehicle was detected. Based on the identifier of the detection point, a DPT of the detection point may be determined. Table 7 represents example data collected in accordance with step 1506.

At 1508, one or more trips for the vehicle may be formed based on the collected detection point data from step 1406. The trips may be constructed based on the techniques described herein including, for example, the trip building techniques described in relation to FIGS. 9-12. As an example, the full sequence of DPTs corresponding to the detection point IDs for the vehicle may be formed (e.g., in chronological order). The full sequence of DPTs for a vehicle may be determined based on a vehicle identifier or other information used to determine all of the detection points where a vehicle was detected. The full sequence of DPTs is then processed by consolidating all consecutive instances of an intra-zonal detection point type. For example, a DPT sequence of “Entry-Entry-IZ-IZ-IZ-IZ-IZ-Exit” may be consolidated to “Entry-Entry-IZ-Exit.” The consolidated full sequence of DPTs may then be compared to the set of valid detection point type sequences constructed in step 1504.

If a match is found, then a trip is determined or declared for the vehicle. If a match is not found, the last DPT element of the consolidated full sequence of DPTs is removed, and the modified consolidated full sequence of DPTs is compared again to the set of valid detection point type sequences constructed in step 1504. This process repeats (e.g., successively removing the last DPT element from a newly modified sequence and then comparing the newly modified sequence to the set of valid DPT sequences) until a first trip is determined for the vehicle. After a first trip for the vehicle is determined, a next trip for the vehicle is determined based on the remaining DPTs of the full DPT sequence for the vehicle that were successively removed to build the first trip. These processes of step 1508 are repeated until one or more trips for the vehicle are constructed based on the full DPT sequence of the vehicle (e.g., until all DPTs associated with the vehicle and collected in step 1504 are addressed/included in at least one trip).

At step 1510, the one or more trips constructed for the vehicle are used to conduct one or more tolling transactions for the vehicle. The tolling transaction may be based on the number of trips determined for the vehicle, the time of day, the type of vehicle, or any other factors.

The method depicted and described in relation to FIG. 15 may be applied to a restricted or excluded roadway environment (e.g., as depicted and described in relation to FIG. 13. For example, as described in relation to Tables 21-24, detection point IDs (e.g., instead of DPTs) may be used to define valid trips and detection points IDs associated with a vehicle's travel may be used to match and form one or more valid vehicle trips.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In some embodiments, a module, system, subsystem, or a portion thereof may be implemented as a hardware circuit comprising custom (very large-scale integration) VLSI circuits or gate arrays, off-the-shelf semiconductors such as logic chips, transistors, or other discrete components. A module, system, subsystem, or a portion thereof may also be implemented in programmable hardware devices such as field programmable gate arrays, programmable array logic, programmable logic devices or the like.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Thus, although there have been described particular embodiments of the present disclosure of new and useful systems and methods dynamically providing content, it is not intended that such references be construed as limitations upon the scope of this disclosure.

What is claimed is:

1. A method for conducting a tolling transaction associated with a vehicle, comprising:
receiving one or more vehicle detection events corresponding to the vehicle, each of the one or more vehicle detection events associated with one of a plurality of detection zones;
generating a plurality of predefined trip patterns, each of the plurality of predefined trip patterns including at least one detection zone of the plurality of detection zones;
matching the one or more vehicle detection events to a longest corresponding trip pattern of the plurality of predefined trip patterns to define a trip for the vehicle; and
causing, based on the defined trip for the vehicle, a toll fee to be charged.

2. The method of claim 1, wherein causing the toll fee to be charged further comprises charging the toll fee to a person associated with the vehicle.

3. The method of claim 1, wherein causing the toll fee to be charged further comprises charging the toll fee to an account associated with the vehicle.

4. The method of claim 1, further comprising sending, to a person associated with the vehicle, a notification of the toll fee.

5. The method of claim 1, wherein receiving comprises receiving, for each vehicle detection event, a timestamp and an identifier of a corresponding detection zone.

6. The method of claim 1, wherein matching further comprises:
constructing, based on the received one or more vehicle detection events, a vehicle detection sequence;
comparing the constructed vehicle detection sequence to the generated plurality of predefined trip patterns; and
selecting, based on the comparing, one of the plurality of predefined trip patterns as the longest corresponding trip pattern.

7. The method of claim 1, wherein the longest corresponding trip pattern comprises a longest chronological sequence of detection zones.

8. The method of claim 1, wherein the one or more vehicle detection events includes at least two vehicle detection events.

9. The method of claim 8, wherein matching further comprises:
determining an average travel time between pairs of detection zones of the plurality of detection zones for each of the plurality of predefined trip patterns that include at least two detection zones of the plurality of detection zones;
comparing a travel time of the vehicle between a pair of detection zones associated with the at least two vehicle detection events with the determined average travel time between the pair of detection zones; and
verifying the defined trip when a difference between the travel time and the average travel time is below a predetermined threshold.

10. The method of claim 1, wherein each of the plurality of detection zones are subdivided based on direction of travel information and each of the plurality of predefined trip patterns includes the direction of travel information.

11. The method of claim 10, wherein at least one of the plurality of predefined trip patterns includes a first detection zone associated with a first direction of travel and a second detection zone associated with a second direction of travel, the second direction of travel different than the first direction of travel.

12. The method of claim 1, wherein matching further comprises:
matching a first portion of the one or more vehicle detection events to one of the plurality of predefined trip patterns to define a first trip; and
matching a second portion of the one or more vehicle detection events to one of the plurality of predefined trip patterns to define a second trip, wherein each vehicle detection event is matched to no more than one of the first portion and the second portion.

13. A method for conducting a tolling transaction associated with a vehicle, comprising:
receiving information indicating a plurality of vehicle detection events corresponding to the vehicle, each of the vehicle detection events associated with one of a plurality of detection zones;
storing a plurality of predefined trip patterns, each predefined trip pattern comprising at least one detection zone of the plurality of detection zones; and
determining, based on the plurality of vehicle detection events and the plurality of predefined trip patterns, a longest matching trip pattern of the plurality of predefined trip patterns to define a trip for the vehicle; and
causing, based on the defined trip, a toll fee to be charged.

14. The method of claim 13, further comprising sending a notification of the toll fee.

15. The method of claim 13, wherein receiving comprises receiving, for each vehicle detection event, a timestamp and an identifier of a corresponding detection zone.

16. The method of claim 13, wherein matching further comprises:
comparing the information indicating the plurality of vehicle detection events to the stored plurality of predefined trip patterns.

17. The method of claim 13, wherein the longest corresponding trip pattern comprises a longest chronological sequence of detection zones.

18. A non-transitory medium storing instructions that, when executed by one or more processors, cause the one or more processors to:
receive one or more vehicle detection events corresponding to the vehicle, each of the one or more vehicle detection events associated with one of a plurality of detection zones;
store a plurality of predefined trip patterns, each of the plurality of predefined trip patterns including at least one detection zone of the plurality of detection zones;
match the one or more vehicle detection events to a longest corresponding trip pattern of the plurality of predefined trip patterns to define a trip for the vehicle; and
cause, based on the defined trip for the vehicle, a toll fee to be charged.

19. The non-transitory medium of claim 18, wherein the instructions, when executed, further cause the one or more processors to:
sending, to a person associated with the vehicle, a notification of the toll fee.

20. The non-transitory medium of claim 18, wherein the longest corresponding trip pattern comprises a longest chronological sequence of detection zones.
